(19) United States
(12) Patent Application Publication
(10) Pub. No.: US 2015/0081696 A1
(43) Pub. Date: Mar. 19, 2015

(54) Systems and Methods for Actively Composing Content for Use in Continuous Social Communication

(71) Applicant: MARKETWIRE L.P., Toronto (CA)

(72) Inventor: Stuart OGAWA, Los Gatos, CA (US)

(73) Assignee: MARKETWIRE L.P., Toronto (CA)

(21) Appl. No.: 14/299,840

(22) Filed: Jun. 9, 2014

Related U.S. Application Data
(60) Provisional application No. 61/880,027, filed on Sep. 19, 2013.

(51) Int. Cl. G06F 17/30

(52) U.S. Cl. CPC G06F 17/30861
USPC 707/736

(57) ABSTRACT

A system and method are provided for analysing and communicating social data. A method performed by a computing device or server system includes obtaining social data and deriving at least two concepts from the social data. A relationship between the at least two concepts is determined. The method also includes composing a new social data object using the relationship and transmitting the new social data object. User feedback associated with new social data object is obtained, and the computing device or server system computes an adjustment command using the user feedback. Executing the adjustment command adjusts a parameter used in the method. After the adjustment command is executed, the method is repeated.

### CROSS-REFERENCE TO RELATED APPLICATIONS

The present application claims priority to U.S. Provisional Application No. 61/880,027 filed on Sep. 19, 2013 and titled “System and Method for Continuous Social Communication”, the contents of which are hereby incorporated by reference in their entirety.

### TECHNICAL FIELD

The following generally relates to composing content for use in communication of social data.

### BACKGROUND

In recent years social media has become a popular way for individuals and consumers to interact online (e.g. on the Internet). Social media also affects the way businesses aim to interact with their customers, fans, and potential customers online.

Typically a person or persons create social media by writing messages (e.g. articles, online posts, blogs, comments, etc.), creating a video, or creating an audio track. This process can be difficult and time consuming.

### BRIEF DESCRIPTION OF THE DRAWINGS

Embodiments will now be described by way of example only with reference to the appended drawings wherein:

FIG. 1 is a block diagram of a social communication system interacting with the Internet or a cloud computing environment, or both.

FIG. 2 is a block diagram of an example embodiment of a computing system for social communication, including example components of the computing system.

FIG. 3 is a block diagram of an example embodiment of multiple computing devices interacting with each other over a network to form the social communication system.

FIG. 4 is a schematic diagram showing the interaction and flow of data between an active receiver module, an active composer module, an active transmitter module and a social analytic synthesizer module.

FIG. 5 is a flow diagram of an example embodiment of computer executable or processor implemented instructions for composing new social data and transmitting the same.

FIG. 6 is a block diagram of an active receiver module showing example components thereof.

FIG. 7 is a flow diagram of an example embodiment of computer executable or processor implemented instructions for receiving social data.

FIG. 8 is a block diagram of an active composer module showing example components thereof.

FIG. 9A is a flow diagram of an example embodiment of computer executable or processor implemented instructions for composing new social data.

FIG. 9B is a flow diagram of an example embodiment of computer executable or processor implemented instructions for combining social data according to an operation described in FIG. 9A.

FIG. 9C is a flow diagram of an example embodiment of computer executable or processor implemented instructions for extracting social data according to an operation described in FIG. 9A.

FIG. 9D is a flow diagram of an example embodiment of computer executable or processor implemented instructions for creating social data according to an operation described in FIG. 9A.

FIG. 10 is a block diagram showing example components of a templates database.

FIG. 11 is an example embodiment of an opinion template.

FIG. 12 is a flow diagram of an example embodiment of computer executable or processor implemented instructions for generating text used to populate the opinion template.

FIG. 13 is an example embodiment of a news article template.

FIG. 14 is a flow diagram of an example embodiment of computer executable or processor implemented instructions for generating text used to populate the news article template.

FIG. 15 is an example embodiment of an earnings press release template.

FIG. 16 is a flow diagram of an example embodiment of computer executable or processor implemented instructions for generating an earnings comparison report.

FIG. 17 is an example embodiment of a product press release template.

FIG. 18 is a flow diagram of an example embodiment of computer executable or processor implemented instructions for generating a product comparison report.

FIG. 19 is a flow diagram of an example embodiment of computer executable or processor implemented instructions for composing a new social data object based on a previously composed social data object.

FIG. 20 is a flow diagram of an example embodiment of computer executable or processor implemented instructions for composing audio and video content.

FIG. 21 is a schematic diagram of an example embodiment of video images and overlaid audio content at different instances in time.

FIG. 22 is a block diagram of an active transmitter module showing example components thereof.

FIG. 23 is a flow diagram of an example embodiment of computer executable or processor implemented instructions for transmitting the new social data.

FIG. 24 is a block diagram of a social analytic synthesizer module showing example components thereof.

FIG. 25 is a flow diagram of an example embodiment of computer executable or processor implemented instructions for determining adjustments to be made for any of the processes implemented by the active receiver module, the active composer module, and the active transmitter module.

### DETAILED DESCRIPTION OF THE DRAWINGS

It will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures and components have not been described in detail so as not to obscure the example embodiments described herein. Also, the description is not to be considered as limiting the scope of the example embodiments described herein.

The proposed systems and methods described herein relate to composing social data. The composed social data can be used in, for example, but is not limited to, the context of continuous social communication. In other words, the system architecture and operations related to the active composer module, described below, may be used with the continuous social communication system described herein, may be used in isolation, or may be used with other systems not described here.

Social data herein refers to content able to be viewed or heard, or both, by people over a data communication network, such as the Internet. Social data includes, for example, text, video, graphics, and audio data, or combinations thereof. Examples of text include blogs, emails, messages, posts, articles, comments, etc. For example, text can appear on websites such as Facebook, Twitter, LinkedIn, Pinterest, other social networking websites, magazine websites, newspaper websites, company websites, blogs, etc. Text may also be in the form of comments on websites, text provided in an RSS feed, etc. Examples of video can appear on Facebook, YouTube, news websites, personal websites, blogs (also called vlogs), company websites, etc. Graphical data, such as pictures, can also be provided through the above mentioned outlets. Audio data can be provided through various websites, such as those mentioned above, audio-casts, “Pod casts”, online radio stations, etc. It is appreciated that social data can vary in form.

A social data object herein refers to a unit of social data, such as a text article, a video, a comment, a message, an audio track, a graphic, or a mixed-media social piece that includes different types of data. A stream of social data includes multiple social data objects. For example, in a string of comments from people, each comment is a social data object. In another example, in a group of text articles, each article is a social data object. In another example, in a group of videos, each video file is a social data object. Social data includes at least one social data object.

It is recognized that effective social communication, from a business perspective, is a significant challenge. The expansive reach of digital social sites, such as Twitter, Facebook, YouTube, etc., the real time nature of communication, the different languages used, and the different communication modes (e.g. text, audio, video, etc.) make it challenging for businesses to effectively listen to and communicate with their customers. The increasing number of websites, channels, and communication modes can overwhelm businesses with too much real time data and little appropriate and relevant information. It is also recognized that people in decision making roles in business are often left wondering who is saying what, what communication channels are being used, and which people are important to listen to.

It is recognized that typically a person or persons generate social data. For example, a person generates social data by writing a message, an article, a comment, etc., or by generating other social data (e.g. pictures, video, and audio data). This generation process, although sometimes partially aided by a computer, is time consuming and uses effort by the person or persons. For example, a person typically types in a text message, and inputs a number of computing commands to attach a graphic or a video, or both. After a person creates the social data, the person will need to distribute the social data to a website, a social network, or another communication channel. This is also a time consuming process that requires input from a person.

It is also recognized that when a person generates social data, before the social data is distributed, the person does not have a way to estimate how well the social data will be received by other people. After the social data has been distributed, a person may also not have a way to evaluate how well the content has been received by other people. Furthermore, many software and computing technologies require a person to view a website or view a report to interpret feedback from other people.

It is also recognized that generating social data that is interesting to people, and identifying which people would find the social data interesting is a difficult process for a person, and much more so for a computing device. Computing technologies typically require input from a person to identify topics of interest, as well as identify people who may be interested in a topic. It also recognized that generating large amounts of social data covering many different topics is a difficult and time-consuming process. Furthermore, it is difficult achieve such a task on a large data scale within a short time frame.

The proposed systems and methods described herein address one or more of these above issues. The proposed systems and methods use one or more computing devices to receive social data, identify relationships between the social data, compose new social data based on the identified relationships and the received social data, and transmit the new social data. In a preferred example embodiment, these systems and methods are automated and require no input from a person for continuous operation. In another example embodiment, some input from a person is used to customize operation of these systems and methods.

The proposed systems and methods are able to obtain feedback during this process to improve computations related to any of the operations described above. For example, feedback is obtained about the newly composed social data, and this feedback can be used to adjust parameters related to where and when the newly composed social data is transmitted. This feedback is also used to adjust parameters used in composing new social data and to adjust parameters used in identifying relationships. Further details and example embodiments regarding the proposed systems and methods are described below.

The proposed systems and methods may be used for real time listening, analysis, content composition, and targeted broadcasting. The systems, for example, capture global data streams of data in real time. The stream data is analyzed and used to intelligently determine content composition and intelligently determine who, what, when, and how the composed messages are to be sent.

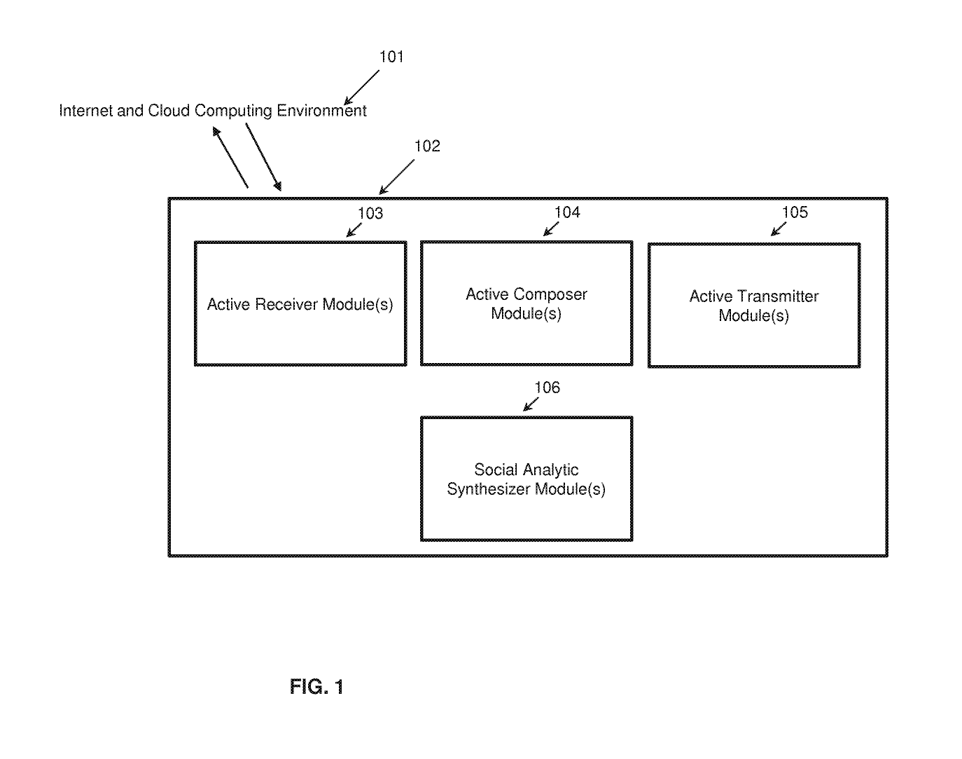

Turning to FIG. 1, the proposed system 102 includes an active receiver module 103, an active composer module 104, an active transmitter module 105, and a social analytic synthesizer module 106. The system 102 is in communication with the Internet or a cloud computing environment, or both 101. The cloud computing environment may be public or may be private. In an example embodiment, these modules function together to receive social data, identify relationships between the social data, compose new social data based on the identified relationships and the received social data, and transmit the new social data.

The active receiver module 103 receives social data from the Internet or the cloud computing environment, or both. The receiver module 103 is able to simultaneously receive social data from many data streams. The receiver module 103 also analyses the received social data to identify relationships amongst the social data. Units of ideas, people, location, groups, companies, words, number, or values are herein referred to as concepts. The active receiver module 103 identifies at least two concepts and identifies a relationship between the at least two concepts. For example, the active receiver module identifies relationships amongst originators of the social data, the consumers of the social data, and the content of the social data. The receiver module 103 outputs the identified relationships.

The active composer module 104 uses the relationships and social data to compose new social data. For example, the composer module 104 modifies, extracts, combines, or synthesizes social data, or combinations of these techniques, to compose new social data. The active composer module 104 outputs the newly composed social data. Composed social data refers to social data composed by the system 102.

The active transmitter module 105 determines appropriate communication channels and social networks over which to send the newly composed social data. The active transmitter module 105 is also configured receive feedback about the newly composed social data using trackers associated with the newly composed social data.

The social analytic synthesizer module 106 obtains data, including but not limited to social data, from each of the other modules 103, 104, 105 and analyses the data. The social analytic synthesizer module 106 uses the analytic results to generate adjustments for one or more various operations related to any of the modules 103, 104, 105 and 106.

In an example embodiment, there are multiple instances of each module. For example, multiple active receiver modules 103 are located in different geographic locations. One active receiver module is located in North America, another active receiver module is located in South America, another active receiver module is located in Europe, and another active receiver module is located in Asia. Similarly, there may be multiple active composer modules, multiple active transmitter modules and multiple social analytic synthesizer modules. These modules will be able to communicate with each other and send information between each other. The multiple modules allows for distributed and parallel processing of data. Furthermore, the multiple modules positioned in each geographic region may be able to obtain social data that is specific to the geographic region and transmit social data to computing devices (e.g. computers, laptops, mobile devices, tablets, smart phones, wearable computers, etc.) belonging to users in the specific geographic region. In an example embodiment, social data in South America is obtained within that region and is used to compose social data that is transmitted to computing devices within South America. In another example embodiment, social data is obtained in Europe and is obtained in South America, and the social data from the two regions are combined and used to compose social data that is transmitted to computing devices in North America.

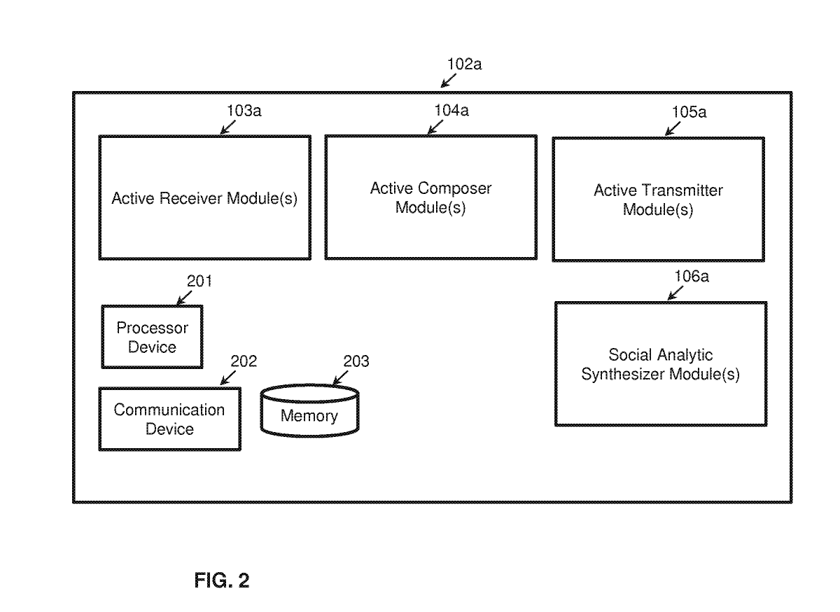

Turning to FIG. 2, an example embodiment of a system 102a is shown. For ease of understanding, the suffix “a” or “b”, etc. is used to denote a different embodiment of a previously described element. The system 102a is a computing device or a server system and it includes a processor device 201, a communication device 202 and memory 203. The communication device is configured to communicate over wired or wireless networks, or both. The active receiver module 103a, the active composer module 104a, the active transmitter module 105a, and the social analytic synthesizer module 106a are implemented by software and reside within the same computing device or server system 102a. In other words, the modules may share computing resources, such as for processing, communication and memory.

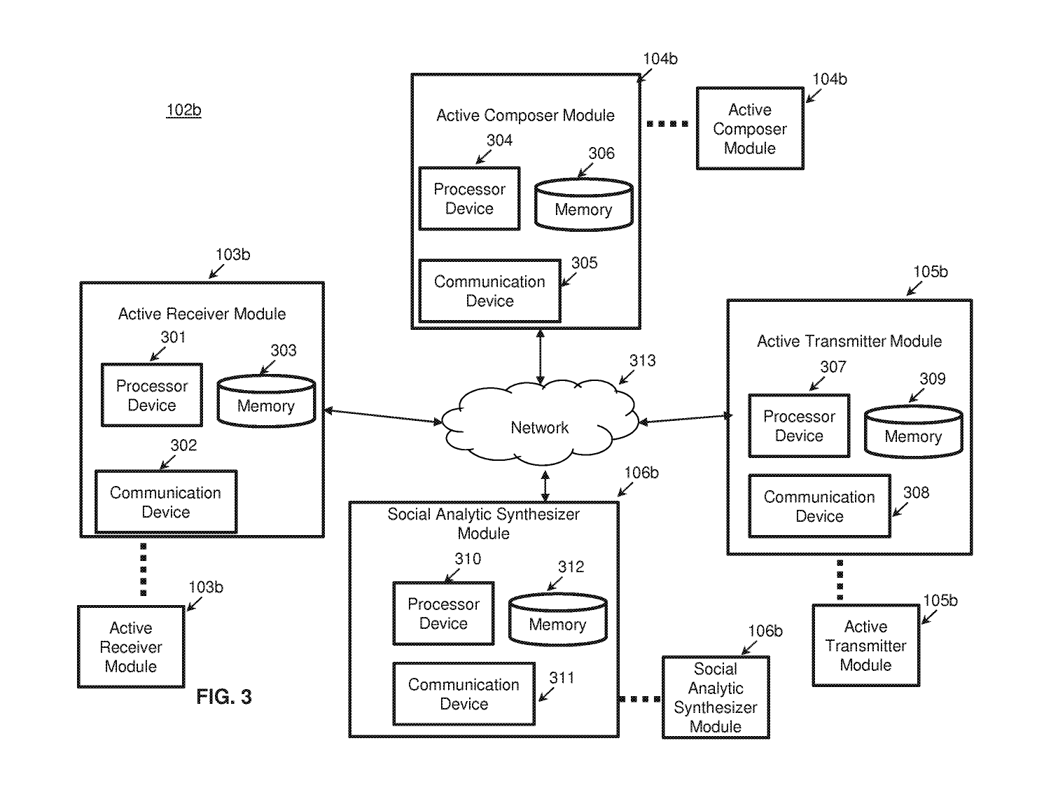

Turning to FIG. 3, another example embodiment of a system 102b is shown. The system 102b includes different modules 103b, 104b, 105b, 106b that are separate computing devices or server systems configured to communicate with each other over a network 313. In particular, the active receiver module 103b includes a processor device 301, a communication device 302, and memory 303. The active composer module 104b includes a processor device 304, a communication device 305, and memory 306. The active transmitter module 105b includes a processor device 307, a communication device 308, and memory 309. The social analytic synthesizer module 106b includes a processor device 310, a communication device 311, and memory 312.

Although only a single active receiver module 103b, a single active composer module 104b, a single active transmitter module 105b and a single social analytic synthesizer module 106b are shown in FIG. 3, it can be appreciated that there may be multiple instances of each module that are able to communicate with each other using the network 313. As described above with respect to FIG. 1, there may be multiple instances of each module and these modules may be located in different geographic locations.

It can be appreciated that there may be other example embodiments for implementing the computing structure of the system 102.

It is appreciated that currently known and future known technologies for the processor device, the communication device and the memory can be used with the principles described herein. Currently known technologies for processors include multi-core processors. Currently known technologies for communication devices include both wired and wireless communication devices. Currently known technologies for memory include disk drives and solid state drives. Examples of the computing device or server systems include dedicated rack mounted servers, desktop computers, laptop computers, set top boxes, and integrated devices combining various features. A computing device or a server uses, for example, an operating system such as Windows Server, Mac OS, Unix, Linux, FreeBSD, Ubuntu, etc.

It will be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the system 102, or any or each of the modules 103, 104, 105, 106, or accessible or connectable thereto. Any application or module herein described may be implemented using computer readable/executable instructions that may be stored or otherwise held by such computer readable media.

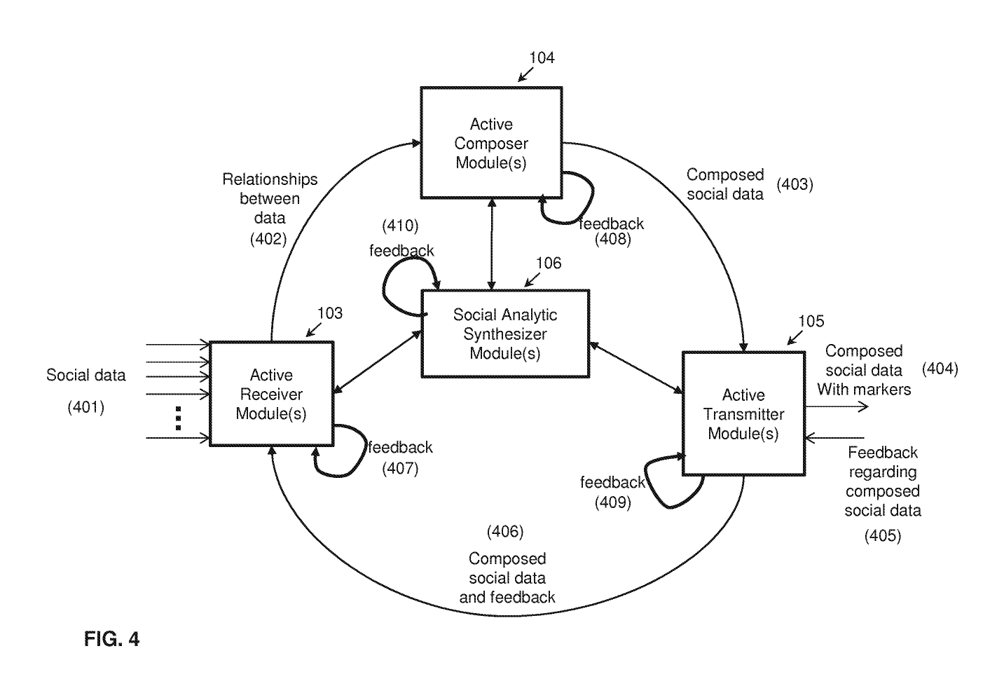

Turning to FIG. 4, the interactions between the modules are shown. The system 102 is configured to listen to data streams, compose automated and intelligent messages, launch automated content, and listen to what people are saying about the launched content.

In particular, the active receiver module 103 receives social data 401 from one or more data streams. The data streams can be received simultaneously and in real-time. The data streams may originate from various sources, such as Twitter, Facebook, YouTube, LinkedIn, Pinterest, blog websites, news websites, company websites, forums, RSS feeds, emails, social networking sites, etc. The active receiver module 103 analyzes the social data, determines or identifies relationships between the social data, and outputs these relationships 402.

In a particular example, the active receiver module 103 obtains social data about a particular car brand and social data about a particular sports team from different social media sources. The active receiver 103 uses analytics to determine there is a relationship between the car brand and the sports team. For example, the relationship may be that buyers or owners of the car brand are fans of the sports team. In another example, the relationship may be that there is a high correlation between people who view advertisements of the car brand and people who attend events of the sports team. The one or more relationships are outputted.

The active composer module 104 obtains these relationships 402 and obtains social data corresponding to these relationships. The active composer module 104 uses these relationships and corresponding data to compose new social data 403. The active composer module 104 is also configured to automatically create entire messages or derivative messages, or both. The active composer module 104 can subsequently apply analytics to recommend an appropriate, or optimal, message that is machine-created using various social data geared towards a given target audience.

Continuing with the particular example, the active composer module 104 composes a new text article by combining an existing text article about the car brand and an existing text article about the sports team. In another example, the active composer module composes a new article about the car brand by summarizing different existing articles of the car brand, and includes advertisement about the sports team in the new article. In another example, the active composer module identifies people who have generated social data content about both the sports team and the car brand, although the social data for each topic may be published at different times and from different sources, and combines this social content together into a new social data message. In another example embodiment, the active composer module may combine video data and/or audio data related to the car brand with video data and/or audio data related to the sports team to compose new video data and/or audio data. Other combinations of data types can be used.

The active transmitter module 105 obtains the newly composed social data 403 and determines a number of factors or parameters related to the transmission of the newly composed social data. The active transmitter module 105 also inserts or adds markers to track people's responses to the newly composed social data. Based on the transmission factors, the active transmitter module transmits the composed social data with the markers 404. The active transmitter module is also configured to receive feedback regarding the composed social data 405, in which collection of the feedback includes use of the markers. The newly composed social data and any associated feedback 406 are sent to the active receiver module 103.

Continuing with the particular example regarding the car brand and the sports team, the active transmitter module 105 determines trajectory or transmission parameters. For example, social networks, forums, mailing lists, websites, etc. that are known to be read by people who are interested in the car brand and the sports team are identified as transmission targets. Also, special events, such as a competition event, like a game or a match, for the sports team are identified to determine the scheduling or timing for when the composed data should be transmitted. Location of targeted readers will also be used to determine the language of the composed social data and the local time at which the composed social data should be transmitted. Markers, such as number of clicks, number of forwards, time trackers to determine length of time the composed social data is viewed, etc., are used to gather information about people's reaction to the composed social data. The composed social data related to the car brand and the sports team and associated feedback are sent to the active receiver module 103.

Continuing with FIG. 4, the active receiver module 103 receives the composed social data and associated feedback 406. The active receiver module 103 analyses this data to determine if there are any relationships or correlations. For example, the feedback can be used to determine or affirm that the relationship used to generate the newly composed social data is correct, or is incorrect.

Continuing with the particular example regarding the car brand and the sports team, the active receiver module 103 receives the composed social data and the associated feedback. If the feedback shows that people are providing positive comments and positive feedback about the composed social data, then the active receiver module determines that the relationship between the car brand and the sports team is correct. The active receiver module may increase a rating value associated with that particular relationship between the car brand and the sports team. The active receiver module may mine or extract even more social data related to the car brand and the sports team because of the positive feedback. If the feedback is negative, the active receiver module corrects or discards the relationship between the car brand and the sports team. A rating regarding the relationship may decrease. In an example embodiment, the active receiver may reduce or limit searching for social data particular to the car brand and the sports team.

Periodically, or continuously, the social analytic synthesizer module 106 obtains data from the other modules 103, 104, 105. The social analytic synthesizer module 106 analyses the data to determine what adjustments can be made to the operations performed by each module, including module 106. It can be appreciated that by obtaining data from each of modules 103, 104 and 105, the social analytic synthesizer has greater contextual information compared to each of the modules 103, 104, 105 individually.

Continuing with the particular example regarding the car brand and the sports team, the social analytic synthesizer module 106 obtains data that people are responding positively to the newly composed social data object in a second language different than a first language used in the newly composed social data object. Such information can be obtained from the active transmitter module 105 or from the active receiver module 103, or both. Therefore, the social analytic synthesizer module sends an adjustment command to the active composer module 104 to compose new social data about the car brand and the sports team using the second language.

In another example, the social analytic synthesizer module 106 obtains data that positive feedback, about the newly composed social data object regarding the car brand and the sports team, is from a particular geographical vicinity (e.g. a zip code, an area code, a city, a municipality, a state, a province, etc.). This data can be obtained by analyzing data from the active receiver module 103 or from the active transmitter module 105, or both. The social analytic synthesizer then generates and sends an adjustment command to the active receiver module 103 to obtain social data about that particular geographical vicinity. Social data about the particular geographical vicinity includes, for example, recent local events, local jargon and slang, local sayings, local prominent people, and local gathering spots. The social analytic synthesizer generates and sends an adjustment command to the active composer module 104 to compose new social data that combines social data about the car brand, the sports team and the geographical vicinity. The social analytic synthesizer generates and sends an adjustment command to the active transmitter module 105 to send the newly composed social data to people located in the geographical vicinity, and to send the newly composed social data during time periods when people are likely to read or consume such social data (e.g. evenings, weekends, etc.).

Continuing with FIG. 4, each module is also configured to learn from its own gathered data and to improve its own processes and decision making algorithms. Currently known and future known machine learning and machine intelligence computations can be used. For example, the active receiver module 103 has a feedback loop 407; the active composer module 104 has a feedback loop 408; the active transmitter module 105 has a feedback loop 409; and the social analytic synthesizer module has a feedback loop 410. In this way, the process in each module can continuously improve individually, and also improve using the adjustments sent by the social analytic synthesizer module 106. This self-learning on a module-basis and system-wide basis allows the system 102 to be completely automated without human intervention.

It can be appreciated that as more data is provided and as more iterations are performed by the system 102 for sending composed social data, then the system 102 becomes more effective and efficient.

Other example aspects of the system 102 are described below.

The system 102 is configured to capture social data in real time.

The system 102 is configured to analyze social data relevant to a business or, a particular person or party, in real time.

The system 102 is configured to create and compose social data that is targeted to certain people or a certain group, in real time.

The system 102 is configured to determine the best or appropriate times to transmit the newly composed social data.

The system 102 is configured to determine the best or appropriate social channels to reach the selected or targeted people or groups.

The system 102 is configured to determine what people are saying about the new social data sent by the system 102.

The system 102 is configured to apply metric analytics to determine the effectiveness of the social communication process.

The system 102 is configured to determine and recommend analysis techniques and parameters, social data content, transmission channels, target people, and data scraping and mining processes to facilitate continuous loop, end-to-end communication.

The system 102 is configured to add N number of systems or modules, for example, using a master-slave arrangement.

It will be appreciated that the system 102 may perform other operations.

In an example embodiment, computer or processor implemented instructions, which are implemented by the system 102, for providing social communication includes obtaining social data. The system then composes a new social data object derived from the social data. It can be appreciated that the new social data object may have exactly the same content of the obtained social data, or a portion of the content of the obtained social data, or none of the content of the obtained social data. The system transmits the new social data object and obtains feedback associated with the new social data object. The system computes an adjustment command using the feedback, wherein executing the adjustment command adjusts a parameter used in the operations performed by the system.

In an example embodiment, the system obtains a social data object using the active receiver module, and the active composer module passes the social data object to the active transmitter module for transmission. Computation and analysis is performed to determine if the social data object is suitable for transmission, and if so, to which party and at which time should the social data object be transmitted.

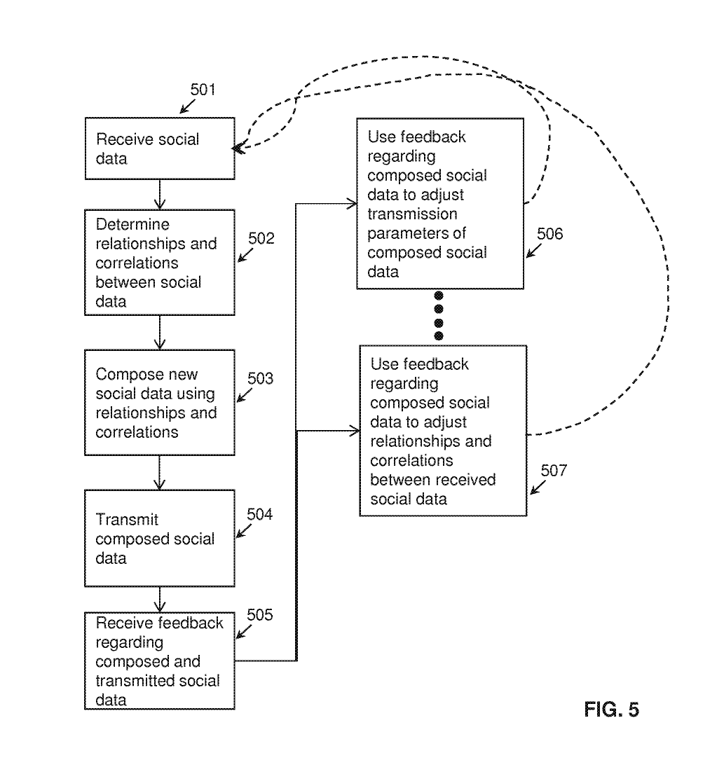

Another example embodiment of computer or processor implemented instructions is shown in FIG. 5 for providing social communication. The instructions are implemented by the system 102. At block 501, the system 102 receives social data. At block 502, the system determines relationships and correlations between social data. At block 503, the system composes new social data using the relationships and the correlations. At block 504, the system transmits the composed social data. At block 505, the system receives feedback regarding the composed social data. At block 506, following block 505, the system uses the feedback regarding the composed social data to adjust transmission parameters of the composed social data. In addition, or in the alternative, at block 507, following block 505, the system uses the feedback regarding the composed social data to adjust relationships and correlations between the received social data. It can be appreciated that other adjustments can be made based on the feedback. As indicated by the dotted lines, the process loops back to block 501 and repeats.

### Active Receiver Module

The active receiver module 103 automatically and dynamically listens to N number of global data streams and is connected to Internet sites or private networks, or both. The active receiver module may include analytic filters to eliminate unwanted information, machine learning to detect valuable information, and recommendation engines to quickly expose important conversations and social trends. Further, the active receiver module is able to integrate with other modules, such as the active composer module 104, the active transmitter module 105, and the social analytic synthesizer module 106.

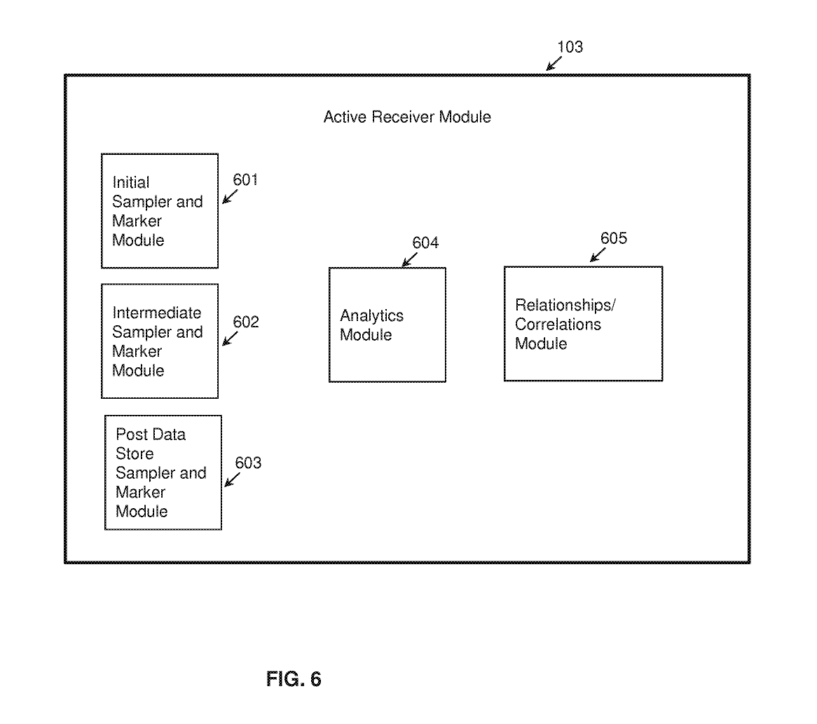

Turning to FIG. 6, example components of the active receiver module 103 are shown. The example components include an initial sampler and marker module 601, an intermediate sampler and marker module 602, a post-data-storage sampler and marker module 603, an analytics module 604, and a relationships/correlations module 605.

To facilitate real-time and efficient analysis of the obtained social data, different levels of speed and granularity are used to process the obtained social data. The module 601 is used first to initially sample and mark the obtained social data at a faster speed and lower sampling rate. This allows the active receiver module 103 to provide some results in real-time. The module 602 is used to sample and mark the obtained data at a slower speed and at a higher sampling rate relative to module 601. This allows the active receiver module 103 to provide more detailed results derived from module 602, although with some delay compared to the results derived from module 601. The module 603 samples all the social data stored by the active receiver module at a relatively slower speed compared to module 602, and with a much higher sampling rate compared to module 602. This allows the active receiver module 103 to provide even more detailed results which are derived from module 603, compared to the results derived from module 602. It can thus be appreciated, that the different levels of analysis can occur in parallel with each other and can provide initial results very quickly, provide intermediate results with some delay, and provide post-data-storage results with further delay.

The sampler and marker modules 601, 602, 603 also identify and extract other data associated with the social data including, for example: the time or date, or both, that the social data was published or posted; hashtags; a tracking pixel; a web bug, also called a web beacon, tracking bug, tag, or page tag; a cookie; a digital signature; a keyword; user and/or company identity associated with the social data; an IP address associated with the social data; geographical data associated with the social data (e.g. geo tags); entry paths of users to the social data; certificates; users (e.g. followers) reading or following the author of the social data; users that have already consumed the social data; etc. This data may be used by the active receiver module 103 and/or the social analytic synthesizer module 106 to determine relationships amongst the social data.

The analytics module 604 can use a variety of approaches to analyze the social data and the associated other data. The analysis is performed to determine relationships, correlations, affinities, and inverse relationships. Non-limiting examples of algorithms that can be used include artificial neural networks, nearest neighbor, Pearson Product Moment Correlation, Bayesian statistics, decision trees, regression analysis, fuzzy logic, K-means algorithm, clustering, fuzzy clustering, the Monte Carlo method, learning automata, temporal difference learning, apriori algorithms, the ANOVA method, Bayesian networks, and hidden Markov models. More generally, currently known and future known analytical methods can be used to identify relationships, correlations, affinities, and inverse relationships amongst the social data. The analytics module 604, for example, obtains the data from the modules 601, 602, and/or 603.

It will be appreciated that inverse relationships between two concepts, for example, is such that a liking or affinity to first concept is related to a dislike or repelling to a second concept.

The relationships/correlations module 605 uses the results from the analytics module to generate terms and values that characterize a relationship between at least two concepts. The concepts may include any combination of keywords, time, location, people, video data, audio data, graphics, etc.

The relationships module 605 can also identify keyword bursts. The popularity of a keyword, or multiple keywords, is plotted as a function of time. The analytics module identifies and marks interesting temporal regions as bursts in the keyword popularity curve. The analytics module identifies one or more correlated keywords associated with the keyword of interest (e.g. the keyword having a popularity burst). The correlated keyword is closely related to the keyword of interest at the same temporal region as the burst. Such a process is described in detail in U.S. patent application Ser. No. 12/501,324, filed on Jul. 10, 2009 and titled “Method and System for Information Discovery and Text Analysis”, the entire contents of which are incorporated herein by reference.

In another example aspect, the relationships module 605 can also identify relationships between topics (e.g. keywords) and users that are interested in the keyword. The relationships module, for example, can identify a user who is considered an expert in a topic. If a given user regularly comments on a topic, and there many other users who “follow” the given user, then the given user is considered an expert. The relationships module can also identify in which other topics that an expert user has an interest, although the expert user may not be considered an expert of those other topics. The relationships module can obtain a number of ancillary users that a given user follows; obtain the topics in which the ancillary users are considered experts; and associate those topics with the given user. The relationships module can also determine content used by the experts and thus create an association or relationship between the experts and the expert's followers, and the content. The content, for example, includes without limitation: frequently used keywords, frequently used keyword pairs, frequently used hashtags, and frequently used links. It can be appreciated that there are various ways to correlate topics and users together. Further details are described in U.S. Patent Application No. 61/837,933, filed on Jun. 21, 2013 and titled “System and Method for Analysing Social Network Data”, the entire contents of which are incorporated herein by reference.

In another aspect, the relationships module 605 is able to identify influencers in a social data network. As used herein, the term “influencer” refers to a user account that primarily produces and shares content related to a topic and is considered to be influential to other users in the social data network. The PageRank algorithm, a known algorithm used by Google to measure the importance of website pages in a network, is used to herein to measure the importance of users in a social data network. User accounts are scored using the PageRank algorithm to determine their influence. In other words, the number of followers a user has is not the sole determinant for determining influence. For example, a user Amy has the greatest number of followers (e.g. Dave, Carol, and Eddie) and is the most influential user in this network (i.e. PageRank score of 46.1%). The user Carol has followers Dave and Eddie, and a PageRank score of 5.6%. Another user Brian has only one follower, who is Amy, and has a PageRank score of 42.3%. Although Brian only has one follower (i.e. Amy), he is more influential than Carol with two followers, primarily because Brian has a significant portion of Amy's mindshare. In other words, although Carol has more followers than Brian, she does not necessarily have a greater influence than Brian. In an example embodiment, identifying who are the followers of a user may also be factored into the computation of influence.

Relationships between an influencer and other users, such as communities of users, are obtained. Relationships between an influencer and content generated by the influencer, or content associated with the influencer's community of users, or both, are obtained.

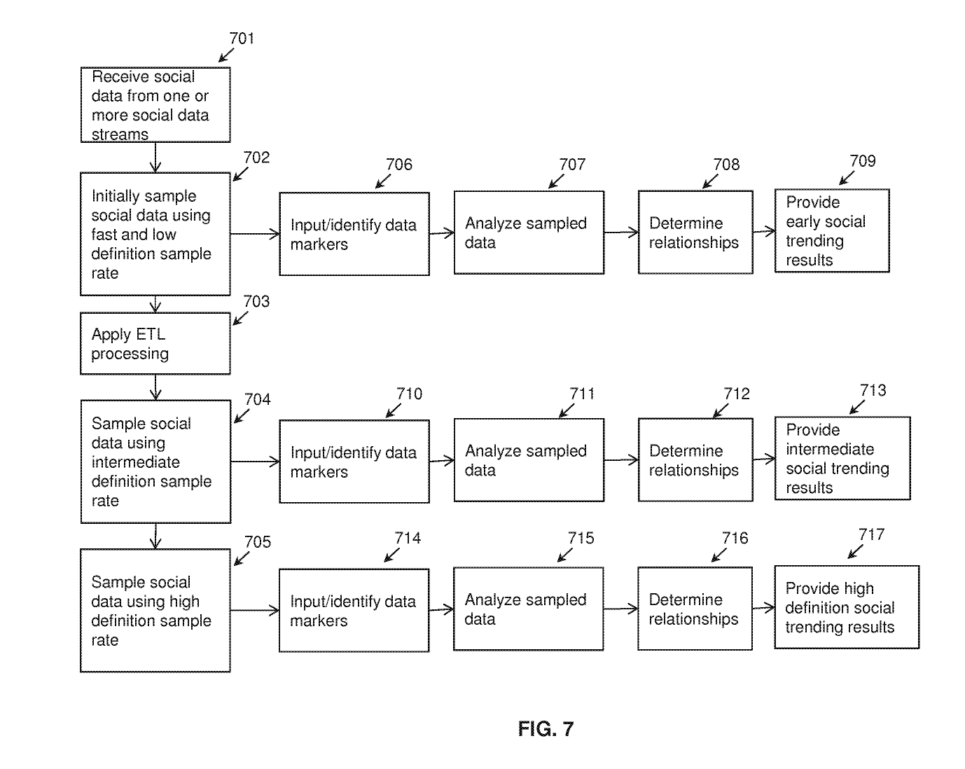

Turning to FIG. 7, example computer or processor implemented instructions are provided for receiving and analysing data according to the active receiver module 103. At block 701, the active receiver module receives social data from one or more social data streams. At block 702, the active receiver module initially samples the social data using a fast and low definition sample rate (e.g. using module 601). At block 703, the active receiver module applies ETL (Extract, Transform, Load) processing. The first part of an ETL process involves extracting the data from the source systems. The transform stage applies a series of rules or functions to the extracted data from the source to derive the data for loading into the end target. The load phase loads the data into the end target, such as the memory.

At block 704, the active receiver module samples the social data using an intermediate definition sample rate (e.g. using 601). At block 705, the active receiver module samples the social data using a high definition sample rate (e.g. using module 603). In an example embodiment, the initial sampling, the intermediate sampling and the high definition sampling are performed in parallel. In another example embodiment, the samplings occur in series.

Continuing with FIG. 7, after initially sampling the social data (block 702), the active receiver module inputs or identifies data markers (block 706). It proceeds to analyze the sampled data (block 707), determine relationships from the sampled data (block 708), and use the relationships to determine early or initial social trending results (block 709).

Similarly, after block 704, the active receiver module inputs or identifies data markers in the sampled social data (block 710). It proceeds to analyze the sampled data (block 711), determine relationships from the sampled data (block 712), and use the relationships to determine intermediate social trending results (block 713).

The active receiver module also inputs or identifies data markers in the sampled social data (block 714) obtained from block 705. It proceeds to analyze the sampled data (block 715), determine relationships from the sampled data (block 716), and use the relationships to determine high definition social trending results (block 717).

In an example embodiment, the operations at block 706 to 709, the operations at block 710 to 713, and the operations at block 714 to 717 occur in parallel. The relationships and results from blocks 708 and 709, however, would be determined before the relationships and results from blocks 712, 713, 716 and 717.

It will be appreciated that the data markers described in blocks 706, 710 and 714 assist with the preliminary analysis and the sampled data and also help to determine relationships. Example embodiments of data markers include keywords, certain images, and certain sources of the data (e.g. author, organization, location, network source, etc.). The data markers may also be tags extracted from the sampled data.

In an example embodiment, the data markers are identified by conducting a preliminary analysis of the sampled data, which is different from the more detailed analysis in blocks 707, 711 and 715. The data markers can be used to identify trends and sentiment.

In another example embodiment, data markers are inputted into the sampled data based on the detection of certain keywords, certain images, and certain sources of data. A certain organization can use this operation to input a data marker into certain sampled data. For example, a car branding organization inputs the data marker “SUV” when an image of an SUV is obtained from the sampling process, or when a text message has at least one of the words “SUV”, “Jeep”, “4x4”, “CR-V”, “Rav4”, and “RDX”. It can be appreciated that other rules for inputting data markers can be used. The inputted data markers can also be used during the analysis operations and the relationship determining operations to detect trends and sentiment.

Other example aspects of the active receiver module are provided below.

The active receiver module 103 is configured to capture, in real time, one or more electronic data streams.

The active receiver module 103 is configured to analyse, in real time, the social data relevant to a business.

The active receiver module 103 is configured to translate text from one language to another language.

The active receiver module 103 is configured to interpret video, text, audio and pictures to create business information. A non-limiting example of business information is sentiment information.

The active receiver module 103 is configured to apply metadata to the received social data in order to provide further business enrichment. Non-limiting examples of metadata include geo data, temporal data, business driven characteristics, analytic driven characteristics, etc.

The active receiver module 103 is configured to interpret and predict potential outcomes and business scenarios using the received social data and the computed information.

The active receiver module 103 is configured to propose user segment or target groups based upon the social data and the metadata received.

The active receiver module 103 is configured to proposed or recommend social data channels that are positively or negatively correlated to a user segment or a target group.

The active receiver module 103 is configured to correlate and attribute groupings, such as users, user segments, and social data channels. In an example embodiment, the active receiver module uses patterns, metadata, characteristics and stereotypes to correlate users, user segments and social data channels.

The active receiver module 103 is configured to operate with little or no human intervention.

The active receiver module 103 is configured to assign affinity data and metadata to the received social data and to any associated computed data. In an example embodiment, affinity data is derived from affinity analysis, which is a data mining technique that discovers co-occurrence relationships among activities performed by (or recorded about) specific individuals, groups, companies, locations, concepts, brands, devices, events, and social networks.

### Active Composer Module

The active composer module 104 is configured to analytically compose and create social data for communication to people. This module may use business rules and apply learned patterns to personalize content. The active composer module is configured, for example, to mimic human communication, idiosyncrasies, slang, and jargon. This module is configured to evaluate multiple social data pieces or objects composed by itself (i.e. module 104), and further configured to evaluate ranks and recommend an optimal or an appropriate response based on the analytics. Further, the active composer module is able to integrate with other modules, such as the active receiver module 103, the active transmitter module 105, and the social analytic synthesizer module 106. The active composer module can machine-create multiple versions of a personalized content message and recommend an appropriate, or optimal, solution for a target audience.

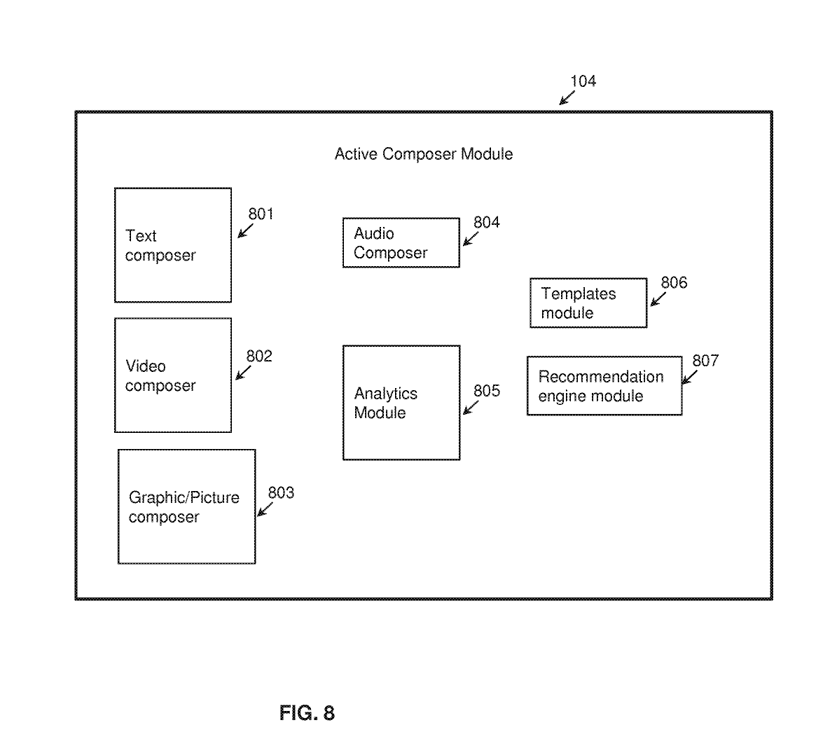

Turning to FIG. 8, example components of the active composer module 104 are shown. Example components include a text composer module 801, a video composer module 802, a graphics/picture composer module 803, an audio composer 804, an analytics module 805, a templates module 806 and a recommendation engine module 807. The composer modules 801, 802, 803 and 804 can operate individually to compose new social data within their respective media types, or can operate together to compose new social data with mixed media types. These composer modules may also operate together with the analytics module, the templates module and the recommendation engine module.

The analytics module 805 is used to analyse the outputted social data, identify adjustments to the composing process, and generate commands to make adjustments to the composing process.

The templates module 806 stores templates and assists in applying the templates to compose new social data objects. The templates may be suited for text, video, graphics, or audio, or a combination thereof.

The recommendation engine module 807 examines recently composed social data objects to determine recommended content for composing new social data objects.

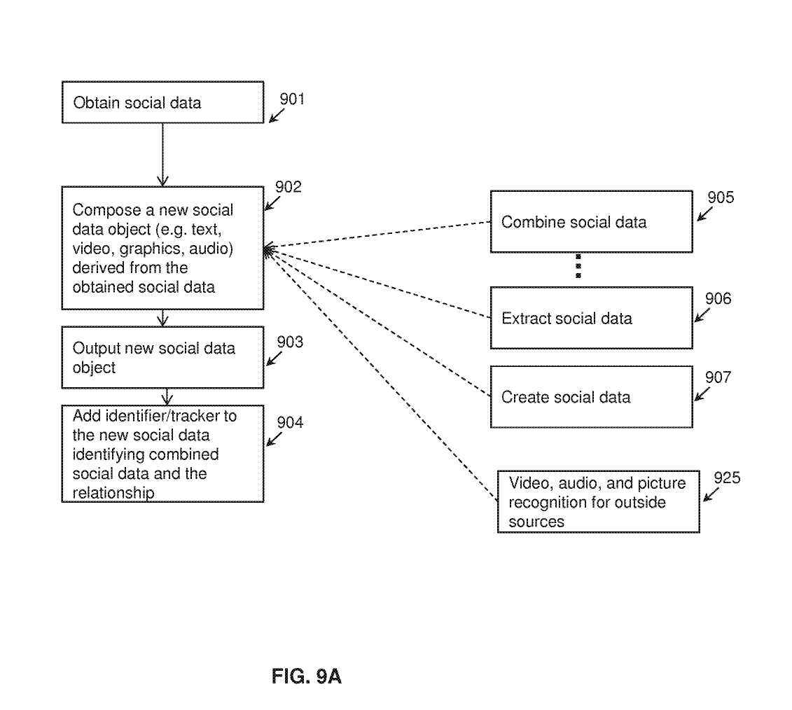

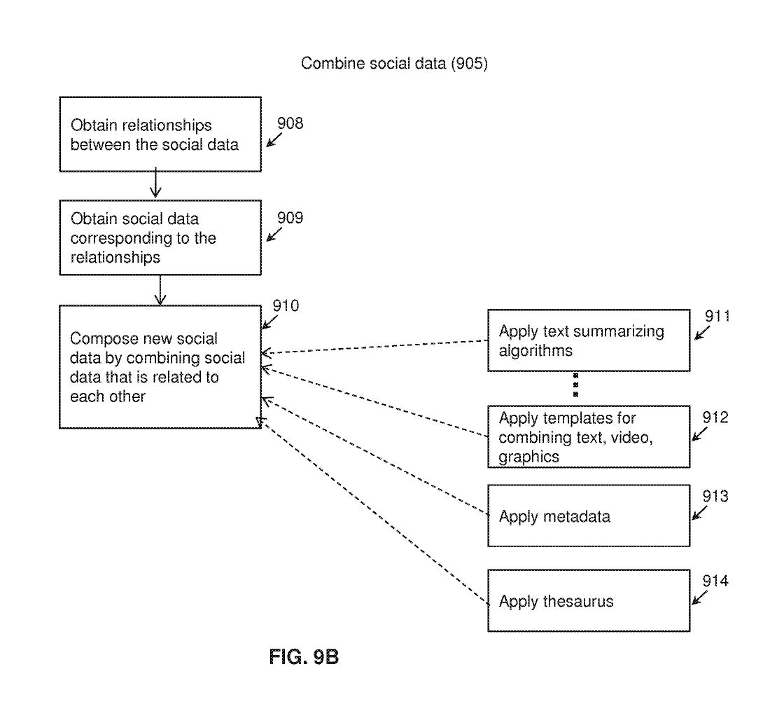

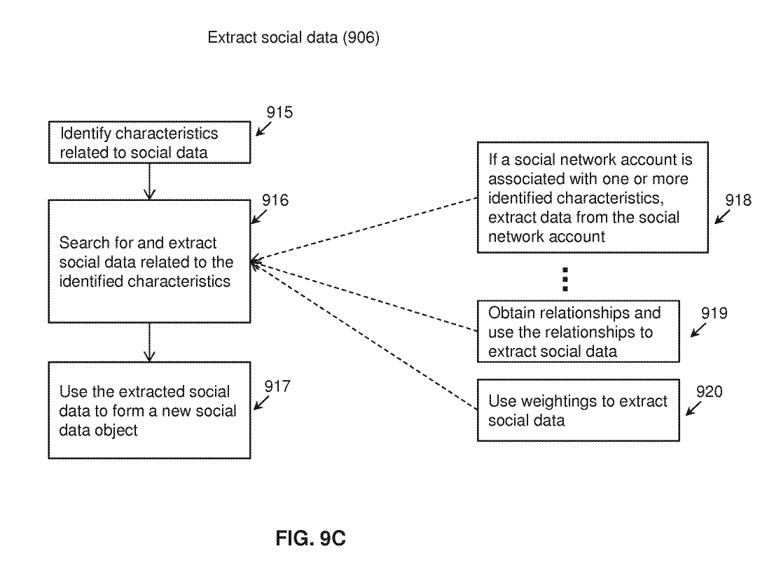

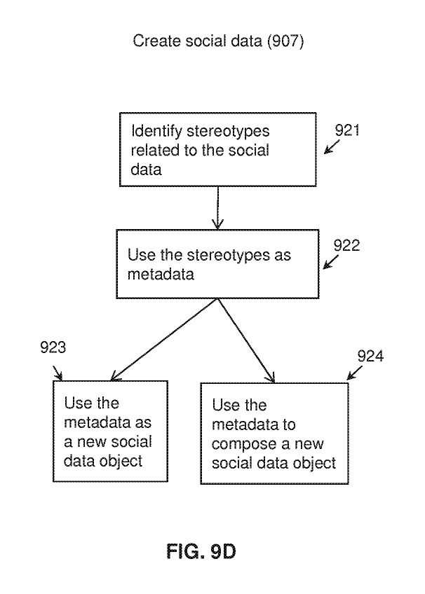

Turning to FIG. 9A, example computer or processor implemented instructions are provided for composing social data according the module 104. The active composer module obtains social data, for example from the active receiver module 103 (block 901). The active composer module then composes a new social data object (e.g. text, video, graphics, audio) derived from the obtained social data (block 902).

Various approaches can be used to compose the new social data object, or new social data objects. For example, social data can be combined to create the new social data object (block 905), social data can be extracted to create the new social object (block 906), and new social data can be created to form the new social data object (block 907). In another example approach, the composer module recognizes external video, audio, and picture content and is able to incorporate this content into composer content, or the content being composed (block 925). The operations from one or more of blocks 905, 906, 907 and 925 can be applied to block 902. Further details in this regard are described in FIGS. 9B, 9C and 9D.

Continuing with FIG. 9A, at block 903, the active composer module outputs the composed social data. The active composer module may also add identifiers or trackers to the composed social data, which are used to identify the sources of the combined social data and the relationship between the combined social data.

Turning to FIG. 9B, example computer or processor implemented instructions are provided for combining social data according to block 905. The active composer module obtains relationships and correlations between the social data (block 908). The relationships and correlations, for example, are obtained from the active receiver module. The active composer module also obtains the social data corresponding to the relationships (block 909). The social data obtained in block 909 may be a subset of the social data obtained by the active receiver module, or may be obtained by third party sources, or both. At block 910, the active composer module composes new social data (e.g. a new social data object) by combining social data that is related to each other.

It can be appreciated that various composition processes can be used when implementing block 910. For example, a text summarizing algorithm can be used (block 911). In another example, templates for combining text, video, graphics, etc. can be used (block 912). In an example embodiment, the templates may use natural language processing to generate articles or essays. The template may include a first section regarding a position, a second section including a first argument supporting the position, a third section including a second argument supporting the position, a fourth section including a third argument supporting the position, and a fifth section including a summary of the position. Other templates can be used for various types of text, including news articles, stories, press releases, etc.

Natural language processing catered to different languages can also be used. Natural language generation can also be used. It can be appreciated that currently know and future known composition algorithms that are applicable to the principles described herein can be used.

Natural language generation includes content determination, document structuring, aggregation, lexical choice, referring expression generation, and realisation. Content determination includes deciding what information to mention in the text. In this case the information is extracted from the social data associated with an identified relationship. Document structuring is the overall organisation of the information to convey. Aggregation is the merging of similar sentences to improve readability and naturalness. Lexical choice is putting words to the concepts. Referring expression generation includes creating referring expressions that identify objects and regions. This task also includes making decisions about pronouns and other types of anaphora. Realisation includes creating the actual text, which should be correct according to the rules of syntax, morphology, and orthography. For example, using “will be” for the future tense of “to be”.

Continuing with FIG. 9B, metadata obtained from the active receiver module, or obtained from third party sources, or metadata that has been generated by the system 102, may also be applied when composing the new social data object (block 913). Furthermore, a thesaurus database, containing words and phrases that are synonymous or analogous to keywords and key phrases, can also be used to compose the new social data object (block 914). The thesaurus database may include slang and jargon. In an example embodiment, entries in the thesaurus database, such as instances of a word or phrase including slang and jargon, are each associated with one or more locations, or one or more demographic characteristics, or both. The associated locations, for example, indicate where each particular entry is commonly used. The associated demographic characteristics (e.g. age, language, ethnicity, gender, education, interests, social groups, etc.) indicate the characteristics of people that commonly use each particular entry. In this way, based on the location of the targeted audience, or the demographic characteristics of the targeted audience, or both, the active composer module is able to select words and phrases from the thesaurus that are appropriate and commonly used according to the targeted audience.

For example, a composed text may describe a teacher as being “stern”. Knowing that the text is geared towards students, which is a demographic characteristic, the active composer module uses the thesaurus database to identify words or phrases to replace the word “stern”. The active composer module identifies that the word “tough” is an appropriate word for the student demographic and, thus, replaces the word “stern” with “tough”.

In another example, a composed text uses the word “toque” to describe a certain type of hat, which is commonly called by name in Canada. However, as the active composer module has obtained data that the composed text is targeted for readers located in the United States, the active composer module searches for words or phrases in the thesaurus database that are better suited for the United States. As an example, the synonym “beanie” is found in the thesaurus database and is associated with the location “United States”. Therefore, “beanie” is used to replace the word “toque”.

Turning to FIG. 9C, example computer or processor implemented instructions are provided for extracting social data according to block 906. At block 915, the active composer module identifies characteristics related to the social data. These characteristics can be identified using metadata, tags, keywords, the source of the social data, etc. At block 916, the active composer module searches for and extracts social data that is related to the identified characteristics.

For example, one of the identified characteristics is a social network account name of a person, an organization, or a place. The active composer module will then access the social network account to extract data from the social network account. For example, extracted data includes associated users, interests, favourite places, favourite foods, dislikes, attitudes, cultural preferences, etc. In an example embodiment, the social network account is a LinkedIn account or a Facebook account. This operation (block 918) is an example embodiment of implementing block 916.

Another example embodiment of implementing block 916 is to obtain relationships and use the relationships to extract social data (block 919). Relationships can be obtained in a number of ways, including but not limited to the methods described herein. Another example method to obtain a relationship is using Pearson's correlation. Pearson's correlation is a measure of the linear correlation (dependence) between two variables X and Y, giving a value between +1 and −1 inclusive, where 1 is total positive correlation, 0 is no correlation, and −1 is negative correlation. For example, if given data X, and it is determined X and data Y are positively correlated, then data Y is extracted.

The relationships between different types of data (e.g. user accounts, influencers, experts, followers, topics, content, locations, etc.) may also be those obtained by the active receiver module 103.

Another example embodiment of implementing block 916 is to use weighting to extract social data (block 920). For example, certain keywords can be statically or dynamically weighted based on statistical analysis, voting, or other criteria. Characteristics that are more heavily weighted can be used to extract social data. In an example embodiment, the more heavily weighted a characteristic is, the wider and the deeper the search will be to extract social data related to the characteristic.

Other approaches for searching for and extracting social data can be used.

At block 917, the extracted social data is used to form a new social data object.

Turning to FIG. 9D, example computer or processor implemented instructions are provided for creating social data according to block 907. At block 921, the active composer module identifies stereotypes related to the social data. Stereotypes can be derived from the social data. For example, using clustering and decision tree classifiers, stereotypes can be computed.

In an example stereotype computation, a model is created. The model represents a person, a place, an object, a company, an organization, or, more generally, a concept. As the system 102, including the composer module, gains experience obtaining data and feedback regarding the social communications being transmitted, the active composer module is able to modify the model. Features or stereotypes are assigned to the model based on clustering. In particular, clusters representing various features related to the model are processed using iterations of agglomerative clustering. If certain of the clusters meet a predetermined distance threshold, where the distance represents similarity, then the clusters are merged. For example, the Jaccard distance (based on the Jaccard index), a measure used for determining the similarity of sets, is used to determine the distance between two clusters. The cluster centroids that remain are considered as the stereotypes associated with the model. For example, the model may be a clothing brand that has the following stereotypes: athletic, running, sports, swoosh, and ‘just do it’.

In another example stereotype computation, affinity propagation is used to identify common features, thereby identifying a stereotype. Affinity propagation is a clustering algorithm that, given a set of similarities between pairs of data points, exchanges messages between data points so as to find a subset of exemplar points that best describe the data. Affinity propagation associates each data point with one exemplar, resulting in a partitioning of the whole data set into clusters. The goal of affinity propagation is to minimize the overall sum of similarities between data points and their exemplars. Variations of the affinity propagation computation can also be used. For example, a binary variable model of affinity propagation computation can be used. A non-limiting example of a binary variable model of affinity propagation is described in the document by Inmar E. Givoni and Brendan J. Frey, titled “A Binary Variable Model of Affinity Propagation”, Neural Computation 21, 1589-1600 (2009), the entire contents of which are hereby incorporated by reference.

Another example stereotype computation is Market Basket Analysis (Association Analysis), which is an example of affinity analysis. Market Basket Analysis is a mathematical modeling technique based upon the theory that if you buy a certain group of products, you are likely to buy another group of products. It is typically used to analyze customer purchasing behavior and helps in increasing the sales and maintain inventory by focusing on the point of sale transaction data. Given a dataset, an apriori algorithm trains and identifies product baskets and product association rules. However, the same approach is used herein to identify characteristics of a person (e.g. stereotypes) instead of products. Furthermore, in this case, users' consumption of social data (e.g. what they read, watch, listen to, comment on, etc.) is analyzed. The apriori algorithm trains and identifies characteristic (e.g. stereotype) baskets and characteristic association rules.

Other methods for determining stereotypes can be used.

Continuing with FIG. 9D, the stereotypes are used as metadata (block 922). In an example embodiment, the metadata is the new social data object (block 923), or the metadata can be used to derive or compose a new social data object (block 924).

It can be appreciated that the methods described with respect to blocks 905, 906 and 907 to compose a new social data object can be combined in various way, though not specifically described herein. Other ways of composing a new social data object can also be applied.

In an example embodiment of composing a social data object, the social data includes the name “Chris Farley”. To compose a new social data object, social data is created using stereotypes. For example, the stereotypes ‘comedian’, ‘fat’, ‘ninja’, and ‘blonde’ are created and associated with Chris Farley. The stereotypes are then used to automatically create a caricature (e.g. a cartoon-like image of Chris Farley). The image of the person is automatically modified to include a funny smile and raised eye brows to correspond with the ‘comedian’ stereotype. The image of the person is automatically modified to have a wide waist to correspond with the ‘fat’ stereotype. The image of the person is automatically modified to include ninja clothing and weaponry (e.g. a sword, a staff, etc.) to correspond with the ‘ninja’ stereotype. The image of the person is automatically modified to include blonde hair to correspond with the ‘blonde’ stereotype. In this way, a new social data object comprising the caricature image of Chris Farley is automatically created. Various graphic generation methods, derived from text, can be used. For example, a mapping database contains words that are mapped to graphical attributes, and those graphical attributes in turn can be applied to a template image. Such a mapping database could be used to generate the caricature image.

In another example embodiment, the stereotypes are used to create a text description of Chris Farley, and to identify in the text description other people that match the same stereotypes. The text description is the composed social data object. For example, the stereotypes of Chris Farely could also be used to identify the actor “John Belushi” who also fits the stereotypes of ‘comedian’ and ‘ninja’. Although the above examples pertain to a person, the same principles of using stereotypes to compose social data also apply to places, cultures, fashion trends, brands, companies, objects, etc.

In an example embodiment, templates are provided for composing text, image, and video social data objects, and can apply the above operations and principles. For example, the determination of which content is used to populate a template is based on the obtained social data and the relationships.

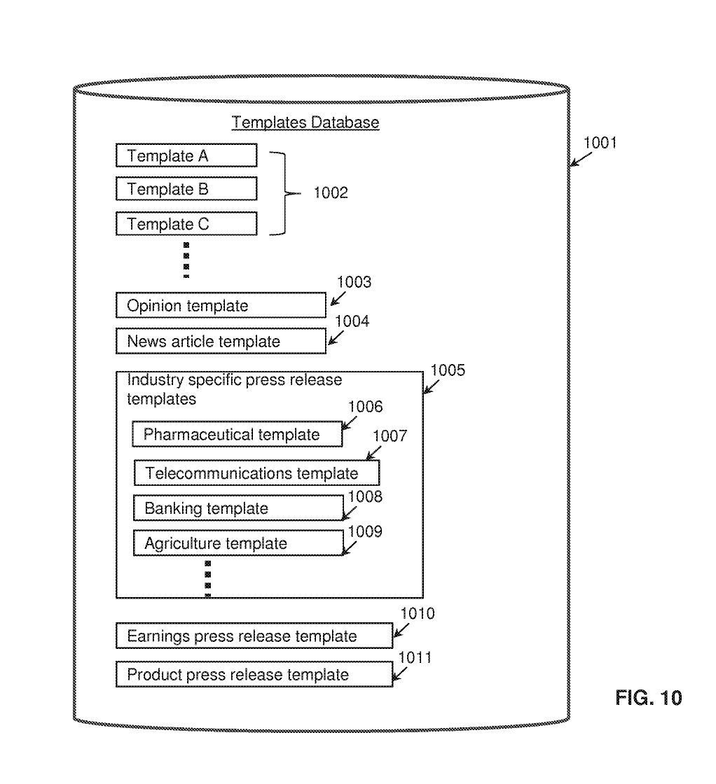

Turning to FIG. 10, a templates database 1001 is provided. The database 1001 is part of the templates module 806. The database 1001 includes various types of templates, such as templates 1002. Some templates are used to generate text files, some templates are to generate audio files, some templates are used for generating images, and some templates are used to generate video files. In general, a template, as used herein, refers to a pre-formatted data object which is combined with content to generate a social data object. In other words, content is used to populate a template, and the content may be formatted or processed to adhere to the format of the template.

Other example types of templates include, without limitation, an opinion template 1003, a news article template 1004, an earnings release template 1010, and a product release template 1011. The database 1001 may also include industry specific press release templates 1005, such as a pharmaceuticals template 1006, a telecommunications template 1007, a banking template 1008, and an agriculture template 1009. It will be appreciated that other templates can be used.

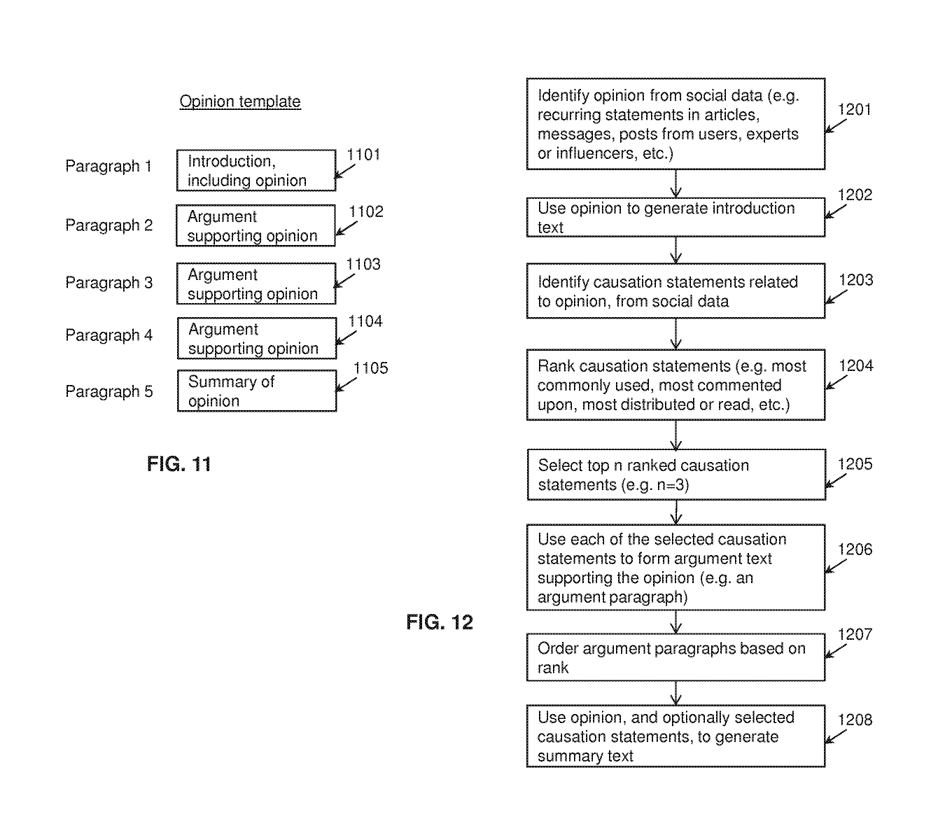

Tuning to FIG. 11, an example of an opinion template is provided. The template outlines paragraphs and the content that should be populated in each paragraph. According to the template, a first paragraph is to be populated by text forming an introduction and a statement about an opinion 1101. A second paragraph, a third paragraph and a fourth paragraph are each to be populated by text forming arguments that support the opinion 1102, 1103, 1104. A fifth paragraph is to be populated by text that summarizes the opinion 1105. It will be appreciated that although five paragraphs are shown, there may be more paragraphs. For example, there may be more than three paragraphs that support the opinion.

Turning to FIG. 12, example computer or processor implemented instructions are provided for generating text to populate the opinion template. At block 1201, the active composer module identifies an opinion from the social data (e.g. the social data and relationships provided by the active receiver module). An opinion, for example, may be identified as a recurring statement identified amongst articles, messages, posts from users, experts and influencers, etc. At block 1202, the opinion is used to generate introduction text, which can be inserted in paragraph 1101 of the opinion template.

At block 1203, the active composer module identifies causation statements related to the opinion, from the social data. A causation statement may be identified by using certain causality terms and language. For example, statements that use the terms “because”, “since”, “due to”, “as a result of”, “caused by”, etc. are identified as causation statements.

In an example embodiment, the opinion is “ABC's product is wonderful”. Causation statements related to such an opinion are extracted from the social data, and examples of such causation statements are: “ABC's product is great because it is easy to use”; “ABC's product is wonderful since it lasts a long time”; and “as a result of the small size, ABC's product is a success”. Causation statements can also be identified using by the relationships and analysis provided by the active receiver module or the social analytic synthesizer module.

Continuing with FIG. 12, at block 1204, the causation statements are ranked. For example, the ranking is based on which causation statement was most commonly used; which causation statement was most commented upon by others; which causation statement was most distributed (e.g. emailed, posted, re-sent, shared, etc.); or which causation statement was most read; or a combination of such ranking criteria. It can be appreciated that other criteria may be used for ranking the causation statements.

At block 1205, the top n ranked causation statements are selected, where n is a natural number. In an example embodiment, n is 3. At block 1206, each of the selected causation statements are used to form test for an argument supporting the opinion (e.g. an argument paragraph).

Continuing with the example regarding the opinion that “ABC's product is wonderful”, the causation statement “ABC's product is great because it is easy to use” is processed to form an argument paragraph. Similarly, the causation statement “ABC's product is wonderful since it lasts a long time” is used to form another argument paragraph. The causation statement “as a result of the small size, ABC's product is a success” is used to form another argument paragraph. Other argument paragraphs can be used and the text may be rearranged using currently known and future-known language processing and language generating algorithms.

Continuing with FIG. 12, at block 1207, the argument paragraphs are ordered according to the ranking of the causation statements. In an example embodiment, the paragraphs are ordered from the top ranked causation statement to the lowest ranked causation statement, or vice versa. In another example embodiment, the argument paragraph related to the second ranked causation statement is positioned as the second paragraph in the template; the argument paragraph related to the third ranked causation statement is positioned as the third paragraph in the template; and the top ranked causation statement is positioned as the fourth paragraph in the template. It will be appreciated that the ordering of the argument paragraphs may vary and, for example, the ordering may be related to the ranking of the causation statements.

At block 1208, the active composer module uses the opinion and, optionally, the selected causation statements, to generate text summarizing the opinion.

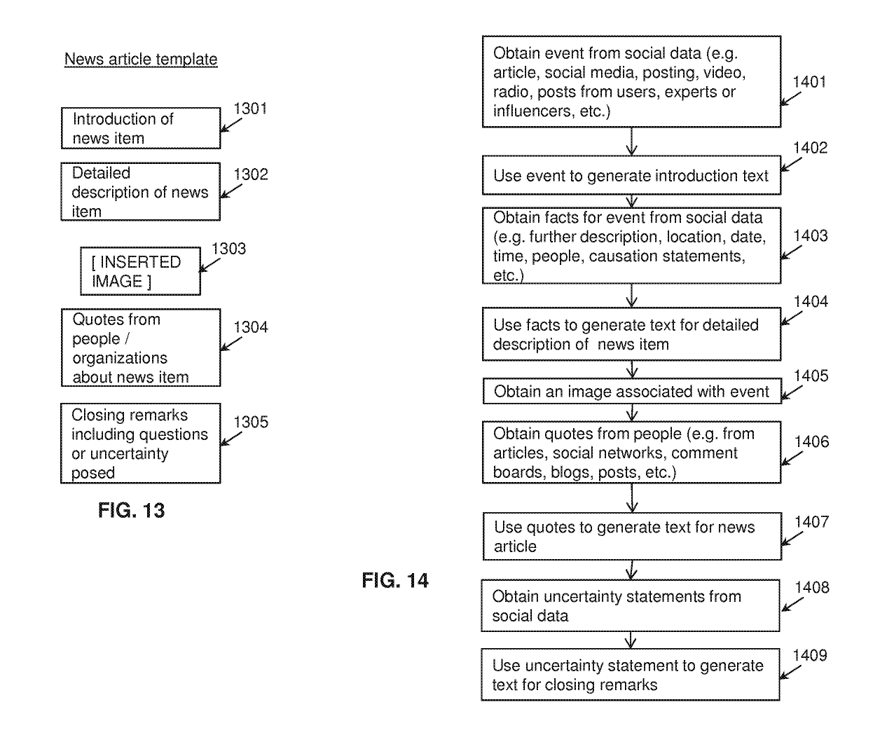

Turning to FIG. 13, an example embodiment of a news article template is shown. The sections shown in the template identify the ordering of certain types of content. Each section may represent one or more sentences or paragraphs of text.

Section 1301 is to be populated by text that introduces a news item, or states what the news item is about. Section 1302 is to be populated by text that provides a detailed description of the new item. Section 1303 is to be populated by an image related to the news item. Section 1304 is to be populated by quotes or paraphrased quotes from people or organizations commenting about the news item. Section 1305 is to be populated by text for closing remarks, and may pose questions or statements of uncertainty.

Turning to FIG. 14, example computer or processor implemented instructions are provided for generating content to populate the news article template. At block 1401, the active composer module obtains text describing an event from the social data. The social data may include articles, social media, postings, video, radio, posts from users, experts or influencers, etc. It is appreciated that text can be obtained from video or radio by using optical character recognition algorithms, or speech-to-text algorithms, or both. At block 1402, the description of the event is used to generate the introduction text to be populated in section 1301 of the template.

At block 1403, the active composer module obtains facts related to the event. The facts are obtained from the social data and may include further details, a location associated with the event, a date or time (or both) associated with the event, names of people or companies associated with the event, causation statements, etc. In an example embodiment, when these detailed facts are described in the same sentence, or same document, or same file, as the event, then these detailed facts are considered related to the event. Other currently known and future-known processes and algorithms for determining correlation and affinity between the detailed facts and the even may be used.

At block 1404, the facts are used to generate text for the detailed description of the news item, and the text is used to populate section 1302 of the template.

At block 1405, an image associated with the event is obtained. For example, the image is tagged with keywords that match the keywords of the event, or the image is posted in another article or in a message that has keywords matching keywords of the event. In this way, for example, the active composer module is able to determine that the image is associated with the event. The image is used to populate section 1303 of the template.

At block 1406, the active composer module obtains quotes from people (e.g. from articles, social networks, comment boards, blogs, posts, etc.) that are related to the event. The quotes may be from people who are considered influencers or experts in the related social network or topic. When obtaining quotes, the name and position of the person providing the comment is also obtained. For example, the active composer module identifies a quote within a posting from a user named John Smith, who is a CEO of 123 Corp., and the quote reads: “Company ABC's new product is a technological marvel!” In this way, when generating quoted text for section 1304, information about the person providing the quote is also used. An example of the generated quoted text is: According to John Smith, CEO of 123 Corp., “Company ABC's new product is a technological marvel!”

In a further example, the generated quoted text includes a link to the data source of the quote. Non-limiting examples of links include a hyperlink, an encoded URL link, a hashtag, a social networking account handle or identifier. For example, if the quote from John Smith was posted on a certain social networking web application or website, then a link to the posting on the certain social networking web application or website is provided in the generated quoted text. For example, the link to the source of the quote may be to a Twitter account, a Twitter posting, a YouTube web page, a blog, a website, or any other data sites. An example of the generated quoted text is: According to John Smith, CEO of 123 Corp., “Company ABC's new product is a technological marvel!” http://t.co/123ABC. The link may be already associated with the quote, and may be part of the data provided to or obtained by the active composer module.

As per block 1407, the quotes and information about the person are used to generate text for the news article.

An example of a text quote template, which can be used in section 1304 of the news article template, is: According to [insert name], “[insert quote]”. Another text quote template is: [insert name] said, “[insert quote]”. Another text quote template, which includes paraphrasing, is: [insert name] believes [insert quote]. Another text quote template is: “[insert quote]”, stated [insert name]. Other sentence templates and structures may be used, and different templates are used within the same news article in order to provide sentence variation.

At block 1408, the active composer module obtains uncertainty statements from the social data, in relation to the event. An uncertainty statement is a statement that casts doubt or uncertainty about an issue or fact related to the event. For example, statements with question marks are considered uncertainty statements. In another example, if a statement includes a certain phrases, such as, “do not understand”, “unclear”, and “do not know”, then the statement is considered an uncertainty statement. For example, the sentence, “It is unclear whether Company ABC's product will be accepted by international markets”, is considered an uncertainty statement. In another example, the sentence, “I don't know how Company ABC will be able to produce enough product to meet demand”, is another uncertainty statement. In another example, the sentence, “Does anyone know when Company ABC's product will be sold?”, is another uncertainty statement.

At block 1409, the active composer module uses an uncertainty statement to generate text for closing remarks, which is used to populate section 1305 of the template. The uncertainty statement may be modified to match the grammar and tone of the news article template.

For example, the uncertainty statement “Does anyone know when Company ABC's product will be sold?”, is applied to the sentence or phrase template: Questions such as ‘[insert uncertainty statement]’ are still to be answered. The outputted closing remarks text is then: Questions such as ‘When will Company ABC's product will be sold?’ are still to be answered.

In another example, the uncertainty statement “It is unclear whether Company ABC's product will be accepted by international markets” is applied to the sentence or phrase template: It remains to be seen [insert uncertainty statement]. The outputted closing remarks text is then: It remains to be seen whether Company ABC's product will be sold.

Other sentence or phrase templates for the closing remarks, which may be used to set the tone, can be used. It is appreciated that tone, from a writing or literature perspective, refers to the attitude of the text (e.g. serious, happy, humorous, somber, factual, positive, sarcastic, etc.).

More generally, each article template, press release template or other text message or posting template is able to draw upon a variety of different sentence templates to form a variety of sentences and paragraphs, and to maintain consistent tone. For example, each sentence template is associated with a certain article, press release, or other text template, as well as a position (e.g. paragraph, sentence number, etc.) within the certain article, press release, or other text template. Each sentence template is also associated with a tone marker, which indicates the tone of the sentence. The active composer module selects sentences with a consistent tone or a complimentary tone for use within the same article, press release, or text message or posting.

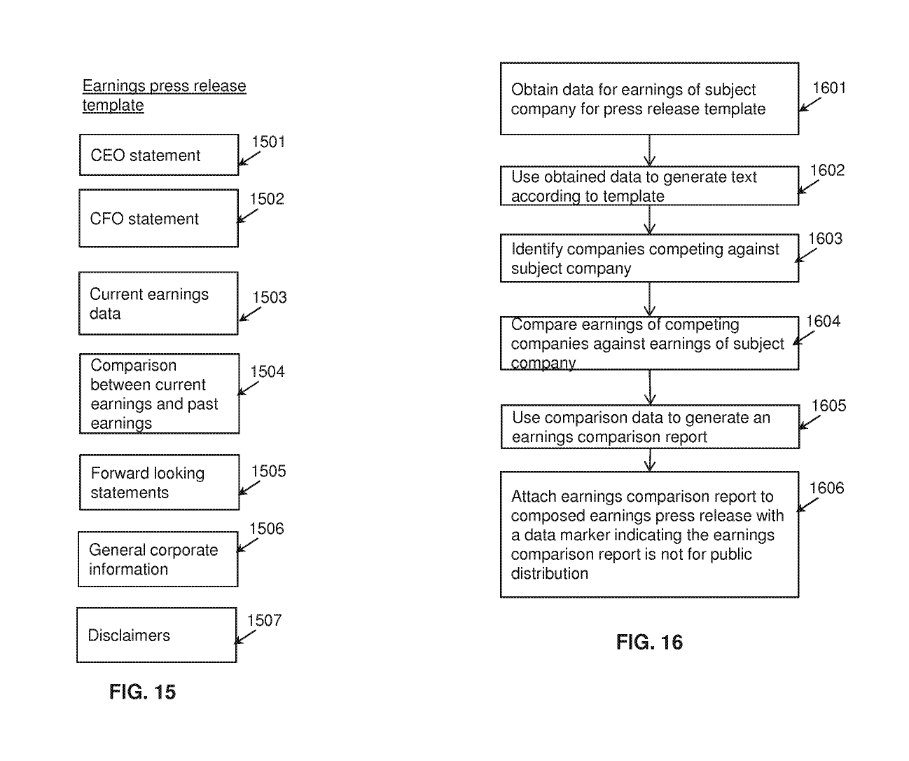

Turning to FIG. 15, an earnings press release template is shown, including the different sections or paragraphs of the earnings press release. Although a specific order of the sections is shown in the example of FIG. 15, different orders can also be used. Each section includes one or more sentences, or one or more paragraphs of text.

Section 1501 is to be populated by text obtained or derived from a CEO statement. Section 1502 is to be populated by text obtained or derived from a CFO statement. Section 1503 is to be populated by text or figures, or both, including the current earnings of a company. Section 1504 is to be populated by text or figures, or both, that compares the current earnings with the past earnings of the same company. Section 1505 is to be populated by text including forward looking statements. Section 1506 is to be populated by text describing the general corporate information of the company. Section 1507 is to be populated by text including disclaimers related to the earnings press release.

The data used to obtain the earnings press release template may be obtained from various social data, including those social data already described, and further including without limitation documents and emails provided by a company, and past press releases.

Turning to FIG. 16, example computer or processor implemented instructions are provided for generating competition intelligence data related to the earnings. These operations can be used in conjunction with generating the earnings press release for a subject company, so that a competition intelligence report is also generated and in association with the earnings press release. At block 1601, the active composer module obtains data for earnings of a subject company for the earnings press release template. The obtained earnings data is used to generate text according to the template (e.g. for section 1503) (block 1602). The active composer module obtains or identifies companies that are competitors of the subject company (block 1603). The active composer module then obtains the earnings data for the competing companies and compares the earnings of competing companies against the earnings of the subject company (block 1604). At block 1605, the comparison data is used to generate an earnings comparison report. At block 1606, earnings comparison report (also called the competition intelligence report) is attached to the composed earnings press release for the subject company. The earnings comparison report is marked with a data marker that indicates the earnings comparison report is, by default, not for public distribution.

In this way, although the earnings press release for the subject company may automatically be publicly distributed, the associated earnings comparison report is not publicly distributed. For example, instead the earnings comparison report is privately distributed to a select customer or a select person or persons (e.g. CFO, CEO, etc.) for private review. The select customer or the select person(s) can then review the earnings press release and the earnings comparison report to gain better competitive intelligence.

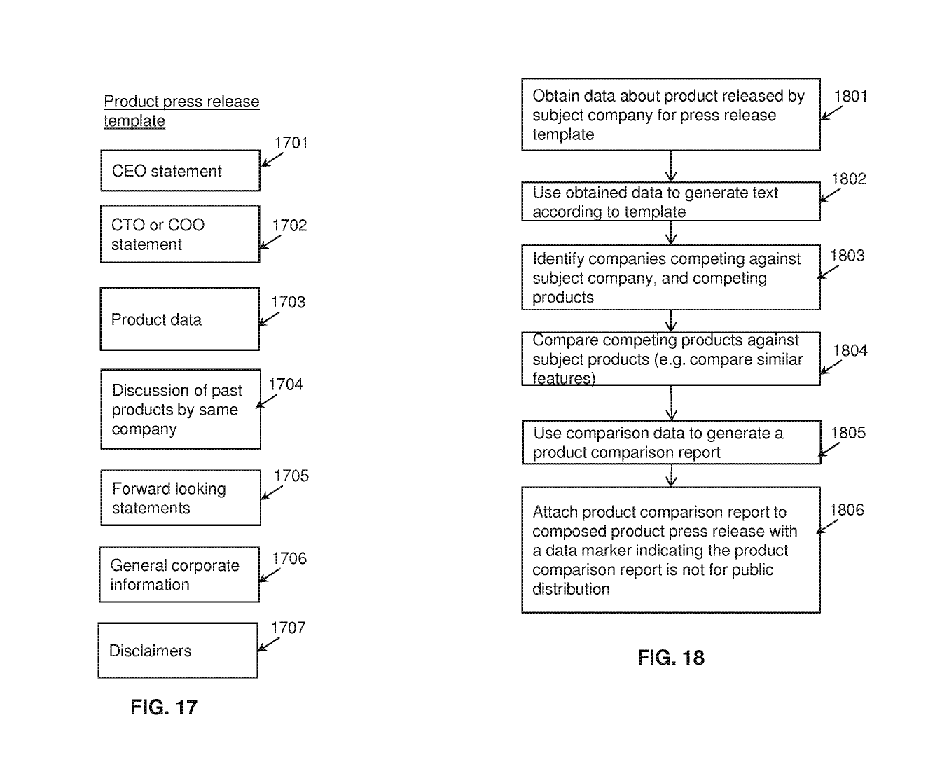

Turning to FIG. 17, a product press release template is shown, including the different sections or paragraphs of the product press release. Although a specific order of the sections is shown in the example of FIG. 17, different orders can also be used. Each section includes one or more sentences, or one or more paragraphs of text.

Section 1701 is to be populated by text obtained or derived from a CEO statement. Section 1702 is to be populated by text obtained or derived from a CTO statement. Section 1703 is to be populated by text or figures, or both, describing the product. Section 1704 is to be populated by text or figures, or both, that compares the current product with past or older products of the same company. Section 1705 is to be populated by text including forward looking statements. Section 1706 is to be populated by text describing the general corporate information of the company. Section 1707 is to be populated by text including disclaimers related to the product press release.

The data used to obtain the product press release template may be obtained from various social data, including those social data already described, and further including without limitation documents and emails provided by a company, and past press releases.

Turning to FIG. 18, example computer or processor implemented instructions are provided for generating competition intelligence data related to the product. These operations can be used in conjunction with generating the product press release for a subject company, so that a competition intelligence report is also generated and in association with the product press release. At block 1801, the active composer module obtains data about a product of a subject company for the product press release template. The obtained product data is used to generate text and figures according to the template (e.g. for section 1703) (block 1802). The active composer module obtains or identifies companies that are competitors of the subject company (block 1803). The active composer module then obtains product data about products provided by the competing companies and compares the competing products against the product of the subject company (block 1804). For example, feature types (e.g. size, weight, cost, function features, performance features, side effects, popularity, battery life, etc.) are identified and are compared between the subject company's product and the competing products. At block 1805, the comparison data is used to generate a product comparison report. At block 1806, the product comparison report (also called the competition intelligence report) is attached to the composed product press release for the subject company. The product comparison report is marked with a data marker that indicates the product comparison report is, by default, not for public distribution.

In this way, although the product press release for the subject company may automatically be publicly distributed, the associated product comparison report is not publicly distributed. For example, instead the product comparison report is privately distributed to a select customer or a select person or persons (e.g. CFO, CTO, etc.) for private review. The select customer or the select person(s) can then review the product press release and the product comparison report to gain better competitive intelligence.

In another aspect, a recommendation engine module 807 examines recently composed social data objects to determine recommended content for composing new social data objects. For example, when generating a composed social data object (e.g. the previously composed social data object), the active composer module can simultaneously, or afterwards, begin collecting data to generate another new composed social data object that is related to, or is follow-up to, the previously composed social data object. In other words, the active composer module automatically starts provisioning the next social data object (e.g. text, audio, video, etc.).

This automatic provisioning includes examining the content of the previously composed social data object to determine or predict ideas and content that should be communicated in the new composed social data object.

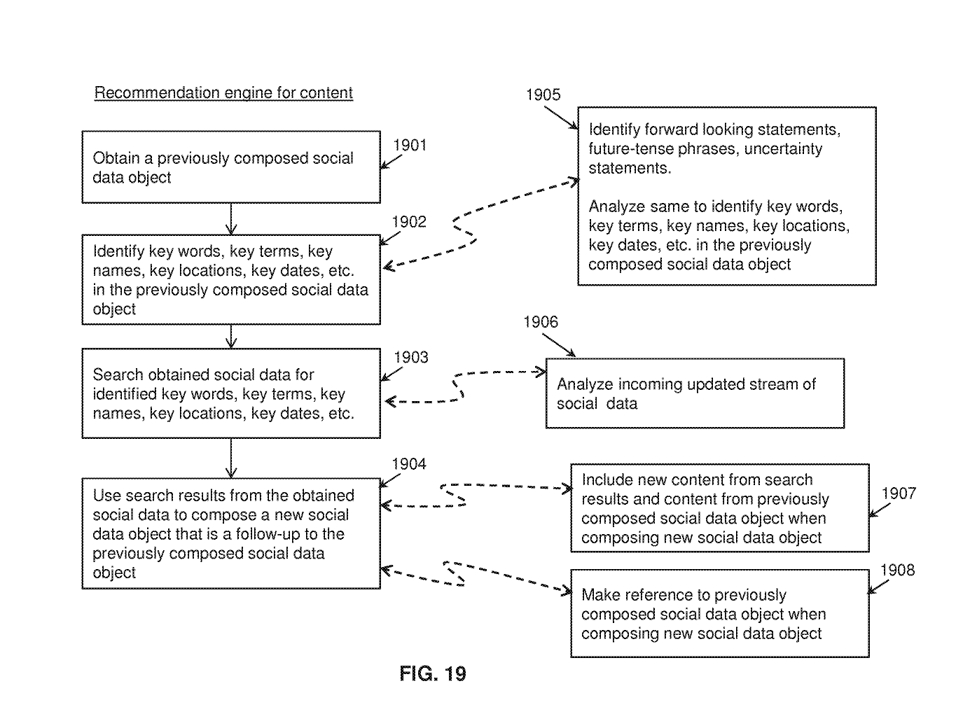

Turning to FIG. 19, example computer or processor implemented instructions are provided for composing a new social data object based on a previously composed social data object. The instructions, for example, may be implemented using module 807, or more generally, the active composer module. At block 1901, the active composer module obtains a previously composed social data object (e.g. a news article, a posting, a press release, a message, an audio file, a video, a picture, etc.).

At block 1902, the active composer module identifies key words, key terms, key names, key locations, key dates, etc. in the previously composed social data object. For pictures and videos, the active composer module may identify key objects, faces, locations, and other metadata associated with the social data object.

In an example embodiment of implementing block 1902, the active composer module identifies forward looking statements, future-tense phrases, and uncertainty statements (block 1905). These identified statements and phrases are analyzed to identify key words, key terms, key names, key locations, key dates, etc. in the previously composed social data object. Other ways of implementing block 1902 may be used.

Continuing with FIG. 19, at block 1903, the active composer module searches social data for identified key words, key terms, key names, key locations, key dates, etc. In an example embodiment of implementing block 1903, the incoming and continuously updated stream of social data obtained by the active receiver module is searched and analyzed. Other ways of implementing block 1903 may be used.

At block 1904, the search results from block 1903 are used to compose a new social data object that is a follow-up to the previously composed social data object.

In an example embodiment of implementing block 1904, the new social data object includes new content from the search results and includes content from the previously composed social data object (block 1907). In another example embodiment, the active composer module makes reference to the previously composed social data object when composing the new social data object (block 1908). Blocks 1907 and 1908 may occur together, or just block 1907 is used, or just block 1908 is used. Other ways of implementing block 1904 may be used.

For example, as per block 1908, the new social data object makes reference by including the title of the previously composed social data object, the date of publication, the publication source, a data link to the previously composed social data object, or any combination thereof.

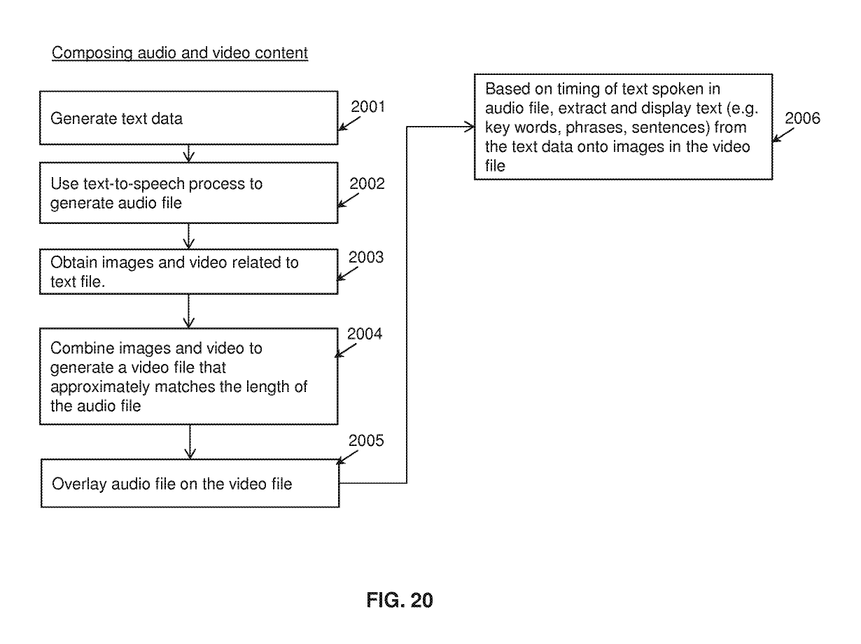

Turning to FIG. 20, example computer or processor executable instructions are provided for composing a social data object comprising audio content, and for composing a social data object comprising video content. The process starts with generating text data (block 2001). The text can be generated or composed in many ways, including the methods described above.

At block 2002, the active composer module uses a text-to-speech process to generate an audio file. In this way the audio content is created.

To create video content, continuing with FIG. 20, at block 2003, the active composer module obtains images and video related to the text data. For example, the images and video were originally published in articles or messages or posts having certain key words or phrases, and those key words and phrases are in the composed text data of block 2001. In another example, the images and video have metadata which matches content or metadata of the text data. Other ways of identifying relationships between images and video with the text data can be used.

At block 2004, the active composer module combines images and video to generate a video file that approximately matches the length of the audio file. For example, the images and video may be concatenated together to form a series of images to form a video. Or images may be inlaid video. Other ways of combining images, or combining video, or combining images and video may be used. As a non-limiting particular example, if the audio file is t seconds long, the generated video file is also approximately t seconds long.

At block 2005, the audio file is overlaid the video file. In this way, the video file has an audio component accompanying the video images.

At block 2006, optionally, based on the timing of the text spoken in the audio file, text from the generated text data is extracted and displayed onto the images in the video file. For example, key words, phrases or sentences can be extracted from the generated text data and displayed in the video file. The text may be displayed as streaming text or static text, overlaid a video image or inlaid, or displayed in another fashion.

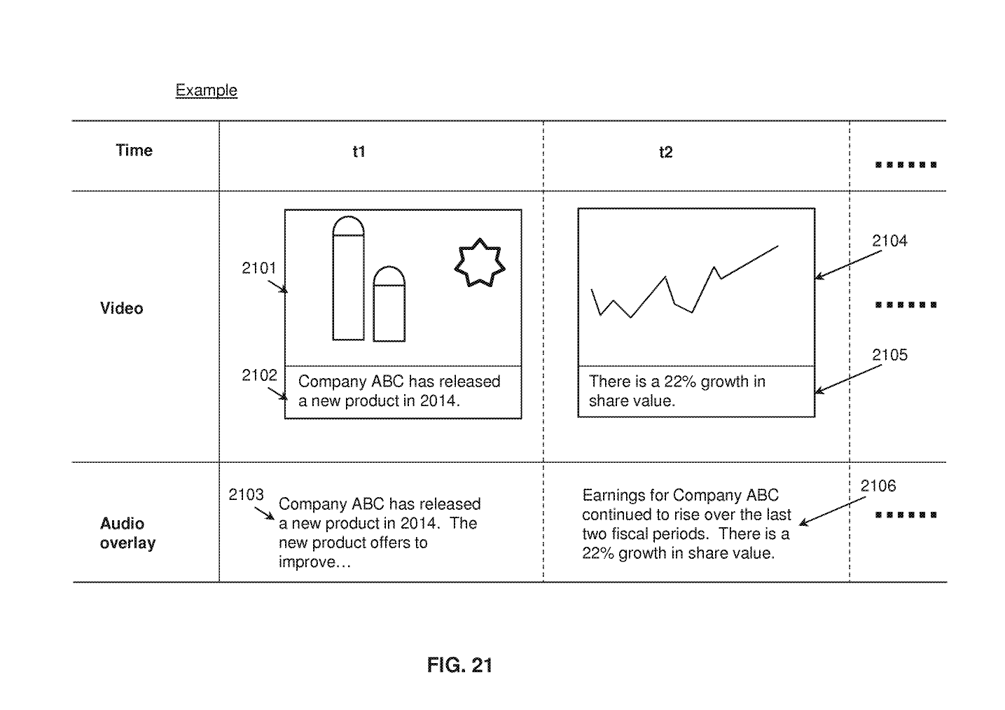

Turning to FIG. 21, an example schematic diagram is provided to illustrate the combined video and audio data, which forms a video file. The generated text data may be a press release from a company related to their new product and earnings. Different instances of time are shown as t1 and t2. At the time t1, a video image 2101 is shown. Also at the same time the video image 2101 is displayed, the audio component 2103 is played and recites “Company ABC has released a new product in 2014. The new product offers to improve . . . ”. Based on the audio content being played at t1, the corresponding text (or a portion thereof) 2102 is displayed in the image. The displayed text 2102 at t1 reads: “Company ABC has released a new product in 2014.”

At time t2, a different image 2104 is shown in the video file. The audio component 2106 being played at time t2 recites: “Earnings for Company ABC continued to rise over the last two fiscal periods. There is a 22% growth in share value.” Thus, the text being extracted and displayed 2105 in the video at time t2 reads: “There is a 22% growth in share value.”

Other display configurations of text and images in the video file can be used. In another example embodiment, there is no audio overlay, and the video file includes only the video and image data combined with the display of text data overlaid the video and image data.

In another aspect, the active composer module 104 is configured to operate with little or no human intervention.

### Active Transmitter Module

The active transmitter module 105 analytically assesses preferred or appropriate social data channels to communicate the newly composed social data to certain users and target groups. The active transmitter module also assesses the preferred time to send or transmit the newly composed social data.

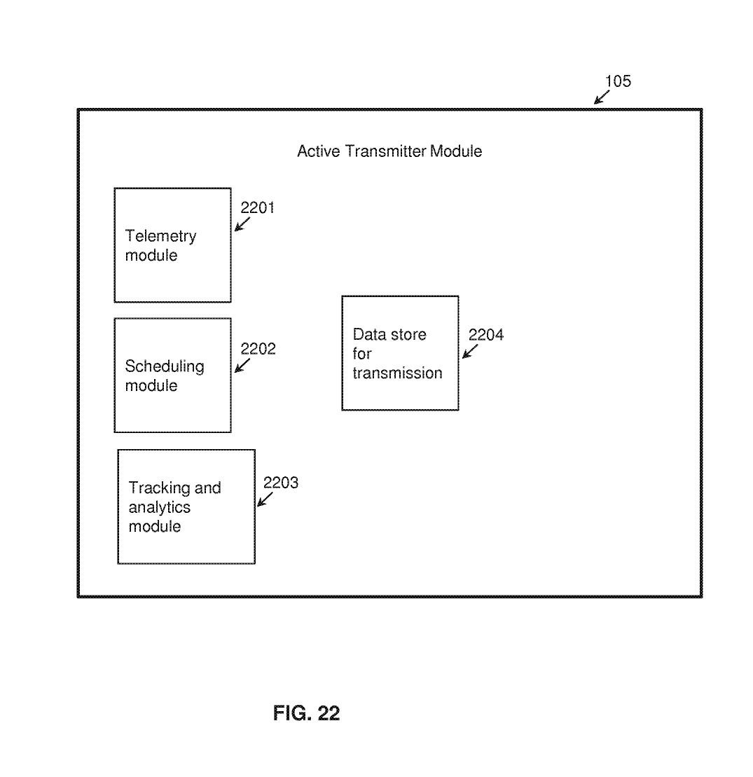

Turning to FIG. 22, example components of the active transmitter module 105 are shown. Example components include a telemetry module 2201, a scheduling module 2202, a tracking and analytics module 2203, and a data store for transmission 2204. The telemetry module 2201 is configured to determine or identify over which social data channels a certain social data object should be sent or broadcasted. A social data object may be a text article, a message, a video, a comment, an audio track, a graphic, or a mixed-media social piece. For example, a social data object about a certain car brand should be sent to websites, RSS feeds, video or audio channels, blogs, or groups that are viewed or followed by potential car buyers, current owners of the car brand and past owners of the car brand. The scheduling module 2202 determines a preferred time range or date range, or both, for sending a composed social data object. For example, if a newly composed social data object is about stocks or business news, the composed social data object will be scheduled to be sent during working hours of a work day. The tracking and analytics module 2203 inserts data trackers or markers into a composed social data object to facilitate collection of feedback from people. Data trackers or markers include, for example, tags, feedback (e.g. like, dislike, ratings, thumb up, thumb down, etc.), number of views on a web page, etc.

The data store for transmission 2204 stores a social data object that has the associated data tracker or marker. The social data object may be packaged as a “cart”. Multiple carts, having the same social data object or different social data objects, are stored in the data store 2204. The carts are launched or transmitted according to associated telemetry and scheduling parameters. The same cart can be launched multiple times. One or more carts may be organized under a campaign to broadcast composed social data. The data trackers or markers are used to analyse the success of a campaign, or of each cart.

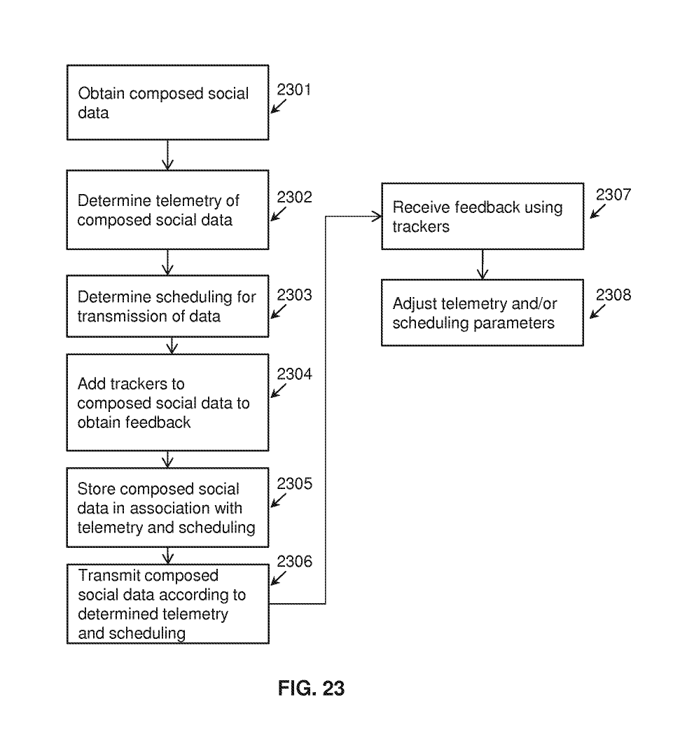

Turning to FIG. 23, example computer or processor implemented instructions are provided for transmitting composed social data according the active transmitter module 105. At block 2301, the active transmitter module obtains the composed social data. At block 2302, the active transmitter module determines the telemetry of the composed social data. At block 2303, the active transmitter module determines the scheduling for the transmission of the composed social data. Trackers, which are used to obtain feedback, are added to the composed social data (block 2304), and the social data including the trackers are stored in association with the scheduling and telemetry parameters (block 2305). At the time determined by the scheduling parameters, the active transmitter module sends the composed social data to the identified social data channels, as per the telemetry parameters (block 2306).

Continuing with FIG. 23, the active transmitter module receives feedback using the trackers (block 2307) and uses the feedback to adjust telemetry or scheduling parameters, or both (block 2308).

Other example aspects of the active transmitter module 105 are provided below.

The active transmitter module 105 is configured to transmits messages and, generally, social data with little or no human intervention

The active transmitter module 105 is configured to uses machine learning and analytic algorithms to select one or more data communication channels to communicate a composed social data object to an audience or user(s). The data communication channels include, but are not limited to, Internet companies such as FaceBook, Twitter, and Bloomberg. Channel may also include traditional TV, radio, and newspaper publication channels.

The active transmitter module 105 is configured to automatically broaden or narrow the target communication channel(s) to reach a certain target audience or user(s).

The active transmitter module 105 is configured to integrate data and metadata from third party companies or organizations to help enhance channel targeting and user targeting, thereby improving the effectiveness of the social data transmission.

The active transmitter module 105 is configured to apply and transmit unique markers to track composed social data. The markers track the effectiveness of the composed social data, the data communication channel's effectiveness, and ROI (return on investment) effectiveness, among other key performance indicators.

The active transmitter module 105 is configured to automatically recommend the best time or an appropriate time to send/transmit the composed social data.

The active transmitter module 105 is configured to listen and interpret whether the composed social data was successfully received by the data communication channel(s), or viewed/consumer by the user(s), or both.

The active transmitter module 105 is configured to analyse the user response of the composed social data and automatically make changes to the target channel(s) or user(s), or both. In an example, the decision to make changes is based on successful or unsuccessful transmission (receipt by user).

The active transmitter module 105 is configured to filter out certain data communication channel(s) and user(s) for future or subsequent composed social data transmissions.

The active transmitter module 105 is configured to repeat the transmission of previously sent composed social data for N number of times depending upon analytic responses received by the active transmitter module. The value of N in this scenario may be analytically determined.

The active transmitter module 105 is configured to analytically determine a duration of time between each transmission campaign.

The active transmitter module 105 is configured to apply metadata from the active composer module 104 to the transmission of the composed social data, in order to provide further business information enrichment. The metadata includes, but is not limited to, geo data, temporal data, business driven characteristics, unique campaign IDs, keywords, hash tags or equivalents, analytic driven characteristics, etc.

The active transmitter module 105 is configured to scale in size, for example, by using multiple active transmitter modules 105. In other words, although one module 105 is shown in the figures, there may be multiple instances of the same module to accommodate large scale transmission of data.

### Social Analytic Synthesizer Module

The social analytic synthesizer module 106 is configured to perform machine learning, analytics, and to make decisions according to business driven rules. The results and recommendations determined by the social analytic synthesizer module 106 are intelligently integrated with any one or more of the active receiver module 103, the active composer module 104, and the active transmitter module 105, or any other module that can be integrated with the system 102. This module 106 may be placed or located in a number of geo locations, facilitating real time communication amongst the other modules. This arrangement or other arrangements can be used for providing low latency listening, social content creation and content transmission on a big data scale.

The social analytic synthesizer module 106 is also configured to identify unique holistic patterns, correlations, and insights. In an example embodiment, the module 106 is able to identify patterns or insights by analysing all the data from at least two other modules (e.g. any two or more of modules 103, 104 and 105), and these patterns or insights would not have otherwise been determined by individually analysing the data from each of the modules 104, 104 and 105. The feedback or an adjustment command is provided by the social analytic synthesizer module 106, in an example embodiment, in real time to the other modules. Over time and over a number of iterations, each of the modules 103, 104, 105 and 106 become more effective and efficient at continuous social communication and at their own respective operations.

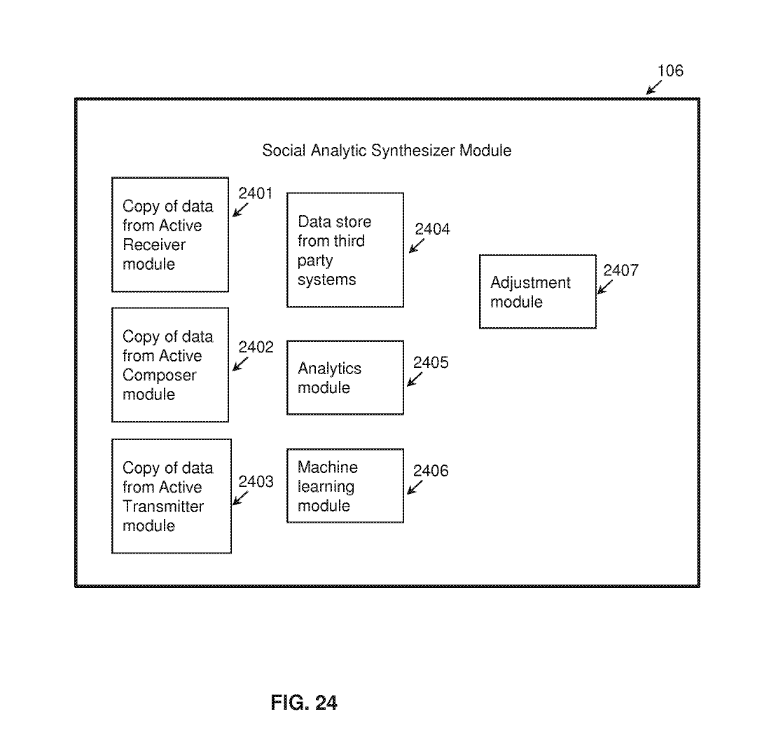

Turning to FIG. 24, example components of the social analytic synthesizer module 106 are shown. Example components include a copy of data from the active receiver module 2401, a copy of data from the active composer module 2402, and a copy of data from the active transmitter module 2403. These copies of data include the inputted data obtained by each module, the intermediary data, the outputted data of each module, the algorithms and computations used by each module, the parameters used by each module, etc. Preferably, although not necessarily, these data stores 2401, 2402 and 2403 are updated frequently. In an example embodiment, the data from the other modules 103, 104, 105 are obtained by the social analytic synthesizer module 106 in real time as new data from these other modules become available.

Continuing with FIG. 24, example components also include a data store from a third party system 2404, an analytics module 2405, a machine learning module 2406 and an adjustment module 2407. The analytics module 2405 and the machine learning module 2406 process the data 2401, 2402, 2403, 2404 using currently known and future known computing algorithms to make decisions and improve processes amongst all modules (103, 104, 105, and 106). The adjustment module 2407 generates adjustment commands based on the results from the analytics module and the machine learning module. The adjustment commands are then sent to the respective modules (e.g. any one or more of modules 103, 104, 105, and 106).

In an example embodiment, data from a third party system 2404 can be from another social network, such as LinkedIn, Facebook, Twitter, etc.

Other example aspects of the social analytic synthesizer module 106 are below.

The social analytic synthesizer module 106 is configured to integrate data in real time from one or more sub systems and modules, included but not limited to the active receiver module 103, the active composer module 104, and the active transmitter module 105. External or third party systems can be integrated with the module 106.

The social analytic synthesizer module 106 is configured to apply machine learning and analytics to the obtained data to search for “holistic” data patterns, correlations and insights.

The social analytic synthesizer module 106 is configured to feed back, in real time, patterns, correlations and insights that were determined by the analytics and machine learning processes. The feedback is directed to the modules 103, 104, 105, and 106 and this integrated feedback loop improves the intelligence of each module and the overall system 102 over time.

The social analytic synthesizer module 106 is configured to scale the number of such modules. In other words, although the figures show one module 106, there may be multiple instances of such a module 106 to improve the effectiveness and response time of the feedback.

The social analytic synthesizer module 106 is configured to operate with little or no human intervention.

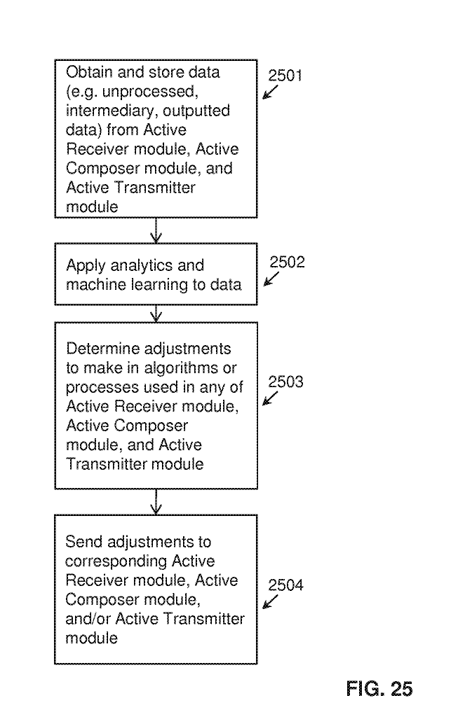

Turning to FIG. 25, example computer or processor implemented instructions are provided for analysing data and providing adjustment commands based on the analysis, according to module 106. At block 2501, the social analytic synthesizer module obtains and stores data from the active receiver module, the active composer module and the active transmitter module. Analytics and machine learning are applied to the data (block 2502). The social analytic synthesizer determines adjustments to make in the algorithms or processes used in any of the active receiver module, active composer module, and the active transmitter module (block 2503). The adjustments, or adjustment commands, are then sent to the corresponding module or corresponding modules (block 2504).

General example embodiments of the systems and methods are described below.

In general, a method performed by a computing device for composing social data, includes: obtaining social data; obtaining at least two concepts based on a relationship between the two concepts from the social data; and composing a new social data object using the at least two concepts and the social data.

In an aspect of the method, the method further includes: transmitting the new social data object; obtaining user feedback associated with new social data object; and computing an adjustment command using the user feedback, wherein executing the adjustment command adjusts a parameter used in the method.

In another aspect of the method, the social data comprises a social data object and the new social data object comprises the social data object.

In another aspect of the method, an active receiver module is configured to at least obtain the social data; an active composer module is configured to at least compose the new social data object; an active transmitter module is configured to at least transmit the new social data object; and wherein the active receiver module, the active composer module and the active transmitter module are in communication with each other.

In another aspect of the method, each of the active receiver module, the active composer module and the active transmitter module are in communication with a social analytic synthesizer module, and the method further comprising the social analytic synthesizer module sending the adjustment command to at least one of the active receiver module, the active composer module and the active transmitter module.

In another aspect of the method, composing the new social data object comprises using natural language generation.

In another aspect of the method, the new social data object is any one of text, a video, a graphic, audio data, or a combination thereof.

In another aspect of the method, the at least two concepts are stereotype features of the social data, and the relationship is a stereotype relationship, and the method further comprises using the stereotype features to compose the new social data object.

In another aspect of the method, the relationship relates the at least two concepts together, and the at least two concepts comprise any combination of the following concepts: a key word, a key phrase, a person, a group of people, a characteristic of a person, a characteristic of a group of people, a brand, a topic, text data, audio data, video data, a location, a date, and multiple instances of each concept.

In another aspect of the method, the at least two concepts are text and are combined using at least one of natural language processing and a text summarizing algorithm.

In another aspect of the method, the at least two concepts are text, the new social data object is text, and the method further includes: identifying a key word or a key phrase in the new social data object; using the key word or the key phrase to search a thesaurus database for a synonymous key word or a synonymous key phrase; and replacing the key word or the key phrase with the synonymous key word or the synonymous key phrase.

In another aspect of the method, the method further includes: obtaining a target audience of the new social data object; and selecting the synonymous key word or the synonymous key phrase according to at least one of a locations and a demographic characteristic associated with the synonymous key word or the synonymous key phrase and indicative of the target audience.

In another aspect of the method, the at least two concepts include at least an opinion statement and multiple causation statements related to the opinion statement, and the method further includes: generating an introductory paragraph of text introducing an opinion derived from the opinion statement; generating multiple supporting paragraphs of text supporting the opinion, each one of the supporting paragraphs derived from one of the multiple causation statements.

In another aspect of the method, the at least two concepts include at least an event and a fact describing the event, and the method further includes: generating an introductory paragraph of text stating the event; and generating an ancillary paragraph of text describing the event, the ancillary paragraph derived from the fact.

In another aspect of the method, the at least two concepts comprise at least an event, a statement from a party in relation to the event, and information identifying the party, and the method further includes: generating an introductory paragraph of text stating the event; and generating an ancillary paragraph of text quoting the party, the ancillary paragraph derived from the statement and the information identifying the party.

In another aspect of the method, the new social data object is a press release for a company, the press release includes information about the company, and the method further includes: identifying a competitor company of the company; performing a comparison of the information about the company against information about the competitor company; and generating a competitive intelligence report using the comparison.

In another aspect of the method, the competitive intelligence report is marked with a data marker indicating the competitive intelligence report is not for public distribution. The data marker is configured to be recognized by the computing system that the competitive intelligence report cannot be mass distributed, and is restricted from being sent or accessed by parties without specific authorization.

In another aspect of the method, the method further includes: marking the new social data object as a previously composed social data object; identifying at least one of a key word and a key term in the previously composed social data object; using the at least one of the key word and the key term to perform a search for other social data; and using results from the search to compose a follow-up social data object that references the previously composed social data object.

In another aspect of the method, composing the new social data object includes: generating text; using a text-to-speech process to generate an audio file; obtaining at least one of images and videos related to the text; generating a video file using the least one of images and videos, the video file having a length that matches a length of the audio file; and overlaying the audio file on the video file.

In general, another method performed by a computing device for communicating social data, includes: obtaining social data; deriving at least two concepts from the social data; determining a relationship between the at least two concepts; composing a new social data object using the relationship; transmitting the new social data object; obtaining user feedback associated with new social data object; and computing an adjustment command using the user feedback, wherein executing the adjustment command adjusts a parameter used in the method.

In an aspect of the method, each of the active receiver module, the active composer module and the active transmitter module are in communication with a social analytic synthesizer module, and the method further includes the social analytic synthesizer module sending the adjustment command to at least one of the active receiver module, the active composer module and the active transmitter module.

In an aspect of the method, the method further includes executing the adjustment command and repeating the method.

In an aspect of the method, obtaining the social data includes the computing device communicating with multiple social data streams in real time.

In an aspect of the method, determining the relationship includes using a machine learning algorithm or a pattern recognition algorithm, or both.

In an aspect of the method, the method further includes determining a social communication channel over which to transmit the new social data object, and transmitting the new social data object over the social communication channel, wherein the social communication channel is determined using at least one of the at least two concepts.

In an aspect of the method, the method further includes determining a time at which to transmit the new social data object, and transmitting the new social data object at the time, wherein the time is determined using at least one of the at least two concepts.

In an aspect of the method, the method further includes adding a data tracker to the new social data object before transmitting the new social data object, wherein the data tracker facilitates collection of the user feedback.

It will be appreciated that different features of the example embodiments of the system and methods, as described herein, may be combined with each other in different ways. In other words, different modules, operations and components may be used together according to other example embodiments, although not specifically stated.

The steps or operations in the flow diagrams described herein are just for example. There may be many variations to these steps or operations without departing from the spirit of the invention or inventions. For instance, the steps may be performed in a differing order, or steps may be added, deleted, or modified.

Although the above has been described with reference to certain specific embodiments, various modifications thereof will be apparent to those skilled in the art without departing from the scope of the claims appended hereto.

1. A method performed by a computing device for composing social data, comprising:
obtaining social data;
obtaining at least two concepts based on a relationship between the two concepts from the social data; and
composing a new social data object using the at least two concepts and the social data.

2. The method of claim 1 further comprising:
transmitting the new social data object;
obtaining user feedback associated with new social data object; and
computing an adjustment command using the user feedback, wherein executing the adjustment command adjusts a parameter used in the method.

3. The method of claim 1 wherein the social data comprises a social data object and the new social data object comprises the social data object.

4. The method of claim 1 wherein an active receiver module is configured to at least obtain the social data; an active composer module is configured to at least compose the new social data object; an active transmitter module is configured to at least transmit the new social data object; and wherein the active receiver module, the active composer module and the active transmitter module are in communication with each other.

5. The method of claim 4 wherein each of the active receiver module, the active composer module and the active transmitter module are in communication with a social analytic synthesizer module, and the method further comprising the social analytic synthesizer module sending the adjustment command to at least one of the active receiver module, the active composer module and the active transmitter module.

6. The method of claim 1 wherein composing the new social data object comprises using natural language generation.

7. The method of claim 1 wherein the new social data object is any one of text, a video, a graphic, audio data, or a combination thereof.

8. The method of claim 1 wherein the at least two concepts are stereotype features of the social data, and the relationship is a stereotype relationship, and the method further comprises using the stereotype features to compose the new social data object.

9. The method of claim 1 wherein the relationship relates the at least two concepts together, and the at least two concepts comprise any combination of the following concepts: a key word, a key phrase, a person, a group of people, a characteristic of the person, a characteristic of the group of people, a brand, a topic, text data, audio data, video data, a location, a date, and multiple instances of each concept.

10. The method of claim 1 wherein the at least two concepts are text and are combined using at least one of natural language processing and a text summarizing algorithm.

11. The method of claim 1 wherein the at least two concepts are text, the new social data object is text, and the method further comprises: identifying a key word or a key phrase in the new social data object; using the key word or the key phrase to search a thesaurus database for a synonymous key word or a synonymous key phrase; and replacing the key word or the key phrase with the synonymous key word or the synonymous key phrase.

12. The method of claim 11 further comprising: obtaining a target audience of the new social data object; and selecting the synonymous key word or the synonymous key phrase according to at least one of a locations and a demographic characteristic associated with the synonymous key word or the synonymous key phrase and indicative of the target audience.

13. The method of claim 1 wherein the at least two concepts comprise at least an opinion statement and multiple causation statements related to the opinion statement, and the method further comprises: generating an introductory paragraph of text introducing an opinion derived from the opinion statement; generating multiple supporting paragraphs of text supporting the opinion, each one of the supporting paragraphs derived from one of the multiple causation statements.

14. The method of claim 1 wherein the at least two concepts comprise at least an event and a fact describing the event, and the method further comprises: generating an introductory paragraph of text stating the event; and generating an ancillary paragraph of text describing the event, the ancillary paragraph derived from the fact.

15. The method of claim 1 wherein the at least two concepts comprise at least an event, a statement from a party in relation to the event, and information identifying the party, and the method further comprises: generating an introductory paragraph of text stating the event; and generating an ancillary paragraph of text quoting the party, the ancillary paragraph derived from the statement and the information identifying the party.

16. The method of claim 1 wherein the new social data object is a press release for a company, the press release includes information about the company, and the method further comprises: identifying a competitor company of the company; performing a comparison of the information about the company against information about the competitor company; and generating a competitive intelligence report using the comparison.

17. The method of claim 16 wherein the competitive intelligence report is marked with a data marker indicating the competitive intelligence report is not for public distribution.

18. The method of claim 1 further comprising: marking the new social data object as a previously composed social data object; identifying at least one of a key word and a key term in the previously composed social data object; using the at least one of the key word and the key term to perform a search for other social data; and using results from the search to compose a follow-up social data object that references the previously composed social data object.

19. The method of claim 1 wherein composing the new social data object comprises: generating text; using a text-to-speech process to generate an audio file; obtaining at least one of images and videos related to the text; generating a video file using the least one of images and videos, the video file having a length that matches a length of the audio file; and overlaying the audio file on the video file.

20. A server system configured to communicate social data, comprising:
a processor;
a communication device;
a memory device; and
wherein the memory device comprises computer executable instructions for at least:
obtaining social data;
obtaining at least two concepts based on a relationship between the two concepts from the social data; and
composing a new social data object using the at least two concepts and the social data.
